(19) United States
(12) Patent Application Publication
(10) Pub. No.: US 2010/0010870 A1
(43) Pub. Date: Jan. 14, 2010

(54) System and Method for Tuning Demand Coefficients

(76) Inventors: Karl Millar, Sunnyvale, CA (US); Paritosh Desai, Santa Clara, CA (US); William Barrows Peale, Berkeley, CA (US)

Correspondence Address: KANG LIM, 3494 CAMINO TASSAJARA ROAD #436, DANVILLE, CA, 94506, US

(21) Appl. No.: 12/481,185

(22) Filed: Jun. 9, 2009

Related U.S. Application Data
(63) Continuation-in-part of application No. 09/741,956, filed on Dec. 20, 2000.

(51) Int. Cl. G06Q 10/00

(52) U.S. Cl. 705/10

(57) ABSTRACT

The present invention relates to a system and method for tuning demand coefficients. Transaction data for product categories is received from a store(s). Price elasticity and uncertainty values are selected for the product categories. This transaction data may be seeded with generic price elasticity and uncertainty values. Product categories where the transaction history is not sufficient enough to generate accurate demand coefficients may be identified. Tuning parameters for a product category are estimated using price elasticity and uncertainty values. The tuning parameters include price elasticity mean and price elasticity standard deviation. A modified likelihood function is generated by applying a normally distributed price elasticity term. The modified likelihood function may then be solved for its maxima, thereby generating tuned demand coefficients which may be output to a pricing optimization system for product price setting, and/or may be stored for later product categories. New sales data may be received from the store(s). This data may be used to retrain the tuned demand coefficients.

### CROSS REFERENCE TO RELATED APPLICATIONS

This is a continuation-in-part of co-pending U.S. application Ser. No. 09/741,956 filed on Dec. 20, 2000, entitled “Econometric Engine”, which is hereby fully incorporated by reference.

### BACKGROUND OF THE INVENTION

The present invention relates to a system and methods for a business tool for tuning demand coefficients. This business tool may be stand alone, or may be integrated into a pricing optimization system to provide more effective pricing of products. More particularly, the present demand coefficient tuning system enables enhanced models for driving business decisions for products and categories of products which have little or no previous pricing sales history.

For a business to properly and profitably function, the pricing of goods and services provided by the business must be competitive. In the extreme, the success or failure of a business may be determined by proper pricing of these goods and services. There are many methods for pricing of products, such as auction, competitor price matching, and cost based approaches. However, historically it has been exemplified that statistical pricing of products using an optimization type system may provide the best business results.

It has been traditionally the case that these optimization systems require models to generate the pricing for products. These models, generally, rely upon demand coefficients, such as price elasticity. Generation of these demand coefficients may be readily performed when there is a wealth of historic pricing data. However, when the availability of historic pricing data is minimal, such as when the product has had a consistent price, or for new products or stores, demand coefficients may be inaccurate or difficult to generate.

The problem with inaccurate demand coefficients is that the model will reflect the inaccuracies. Pricing guidance may be generated from these inaccurate models. The pricing guidance may, in turn, result in detrimental business decisions. In addition, confidence in the pricing system may be undermined when the pricing guidance results in decreased sales or profit loss. Thus, accurate future pricing guidance may be ignored, again to the business' disadvantage.

Currently, some optimization systems attempt to reduce the chances of wild price swings when historic pricing data is minimal by incorporating penalty values in the optimization equations. Thus, without strong factors driving the optimized price, the penalty may dominate keeping the generated prices close to the original prices. The disadvantage of such systems is that while these prices may prevent damaging pricing guidance, the newly generated prices may not reflect profit maximization, or other pricing goal. Additionally, since there is little to no change in pricing, the new data generated will not serve to improve modeling data.

It is therefore apparent that an urgent need exists for improved system for tuning demand coefficients for low historic pricing data products or product categories. This improved coefficient tuning system may be used to generate optimized pricing which more effectively achieves the optimization goal, be it profit maximization, margin goals or volume goals.

### SUMMARY OF THE INVENTION

To achieve the foregoing and in accordance with the present invention, a system and method for tuning demand coefficients is provided. This system and method is of particular use when in association with a pricing optimization system. In particular, the system and methods for tuning demand coefficients includes receiving data from store. This data usually includes transactions associated with at least one product category.

Price elasticity and uncertainty values are selected for the product categories. A data seeder may also seed this transaction data with generic price elasticity and uncertainty values. A deficient category identifier may select product categories where the transaction history is not sufficient enough to generate accurate demand coefficients.

A tuning parameter value estimator may then estimate tuning parameters for a product category. The tuning parameters include price elasticity mean and price elasticity standard deviation. These estimates are made using the selected price elasticity and uncertainty values. The price elasticity mean is defined by the equation:

$$μ = \frac{{\sum }_{i = 1}^{N} \frac{{γ}_{i}}{{s}_{i}^{2}}}{( {\sum }_{i = 1}^{N} \frac{1}{{s}_{i}^{2}} )}$$

wherein, N=the number of the product category, μ=the price elasticity mean, γ=the price elasticity; and s=the uncertainty. Likewise, the price elasticity standard deviation is defined by the equation:

$${σ}^{2} = \frac{1}{{\sum }_{i = 1}^{N} \frac{1}{{s}_{i}^{2}}} ( {\sum }_{i = 1}^{N} \frac{{( γ - μ )}^{2}}{{s}_{i}^{2}} + N )$$

wherein, N=the number of the product category, μ=the price elasticity mean, σ=the standard deviation, γ=the price elasticity; and s=the uncertainty.

A coefficient generator may then produce a modified likelihood function by applying a normally distributed price elasticity term. The modified likelihood function may then be solved for its maxima, thereby generating tuned demand coefficients. Solving for the maxima may include maximizing the function analytically, and/or passing a logarithm of the likelihood function to a multivariate numerical optimization routine.

The generated tuned demand coefficients may be output to the pricing optimization system for product price setting. Additionally, the tuned demand coefficients may be stored for later product categories.

In some embodiments, new sales data may be received from the store(s). This new data may then be used to retrain the tuned demand coefficients.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a high level schematic view of an embodiment of a price optimization system with an integrated coefficient tuning system;

FIG. 2 is high level flowchart of an optimization process with integrated coefficient tuning;

FIG. 3 is a more detailed schematic view of the econometric engine;

FIG. 4 is a more detailed schematic view of the optimization engine and support tool;

FIG. 5 is a block diagram to illustrate some of the transaction costs that occur in retail businesses of a chain of stores;

FIG. 6 is a flowchart of some embodiment of the invention for providing an initial feasible solution;

FIGS. 7A and 7B illustrate a computer system, which forms part of a network and is suitable for implementing embodiments of the present invention;

FIG. 8 is a schematic illustration of an embodiment of the invention that functions over a network;

FIG. 9A is a graph of original profit from actual sales of the store using actual prices and optimal profit from optimized sales resulting from the calculated optimized prices bounded by its probability;

FIG. 9B is a graph of percentage increase in profit and the probability of obtaining at least that percentage increase in profit;

FIG. 10 is a flowchart depicting a process flow by which raw econometric data can be input, subject to “cleansing”, and used to create an initial dataset which can then be used to generate imputed econometric variables in accordance with some embodiment of the present invention;

FIG. 11 is a flowchart depicting a process flow depicting a process by which partially cleansed econometric data is subject to further error detection and correction in accordance with some embodiment of the present invention;

FIG. 12 is a flowchart depicting a process flow by which an imputed base price variable can be generated in accordance with one embodiment of the present invention;

FIG. 13 is a flowchart depicting a process flow by which an imputed relative price variable can be generated in accordance with one embodiment of the present invention;

FIG. 14A is a flowchart depicting a process flow by which an imputed base unit sales volume variable can be generated in accordance with one embodiment of the present invention;

FIG. 14B is a diagram used to illustrate the comparative effects of sales volume increase and price discounts;

FIG. 15A is a flowchart depicting a process flow by which supplementary error detection and correction in accordance with an embodiment of the present invention;

FIG. 15B is a diagram used to illustrate the comparative effects of sales volume increase and price discounts;

FIG. 16 is a flowchart depicting a process flow by which an imputed stockpiling variable can be generated in accordance with an embodiment of the present invention;

FIG. 17 is a flowchart depicting a process flow by which an imputed day-of-week variable can be generated in accordance with an embodiment of the present invention;

FIG. 18 is a flowchart depicting a process flow by which an imputed seasonality variable can be generated in accordance with an embodiment of the present invention;

FIG. 19 is a flowchart depicting a process flow by which an imputed promotional effects variable can be generated in accordance with an embodiment of the present invention;

FIG. 20 is a flowchart depicting a process flow by which an imputed cross-elasticity variable can be generated in accordance with some embodiment of the present invention;

FIG. 21 is a more detailed schematic view of the coefficient tuning engine;

FIG. 22 is a more detailed schematic view of the deficient tuning parameter identifier of the coefficient tuning engine;

FIG. 23 is a more detailed schematic view of the tuning parameter value estimator of the coefficient tuning engine;

FIG. 24 is a more detailed schematic view of the coefficient generator of the coefficient tuning engine;

FIG. 25 is a flowchart depicting a process flow by which coefficient tuning may be performed in accordance with some embodiment of the present invention;

FIG. 26 is a flowchart depicting a process flow by which deficient coefficients are identified in accordance with some embodiment of the present invention;

FIG. 27 is a flowchart depicting a process flow by which tuning parameters are estimated in accordance with some embodiment of the present invention;

FIG. 28 is a flowchart depicting a process flow by which tuned coefficients are generated in accordance with some embodiment of the present invention; and

FIG. 29 is a flowchart depicting an alternate process flow by which optimized prices may be generated using a coefficient tuning stratagem in accordance with some embodiment of the present invention.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

The present invention relates to a system and methods for a business tool for tuning demand coefficients, particularly when historic pricing data is absent of deficient. This business tool may be stand alone, or may be integrated into a pricing optimization system to provide more effective pricing of products. For example, the tuned coefficients may be incorporated into price optimization by aiding in generating more accurate demand models. More particularly, in cases where historic pricing data is sparse, such as when a new product is launched, in a new store or where the price of a product has been substantially static for a long time, the coefficient tuning engine may be able to utilize tuning parameters from various other product categories to generate tuned coefficients.

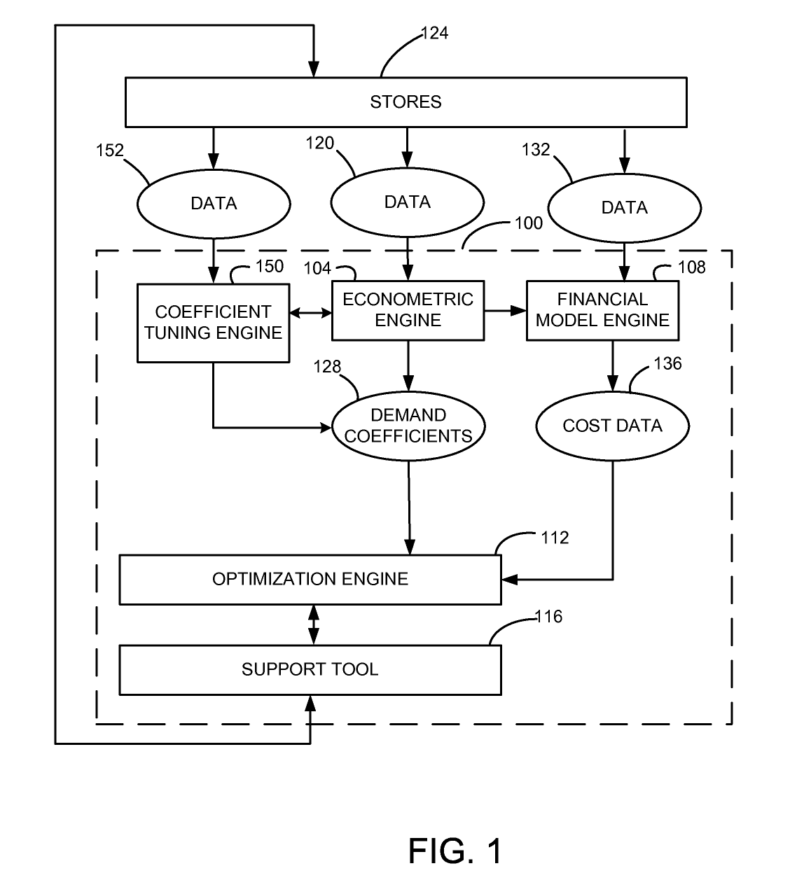

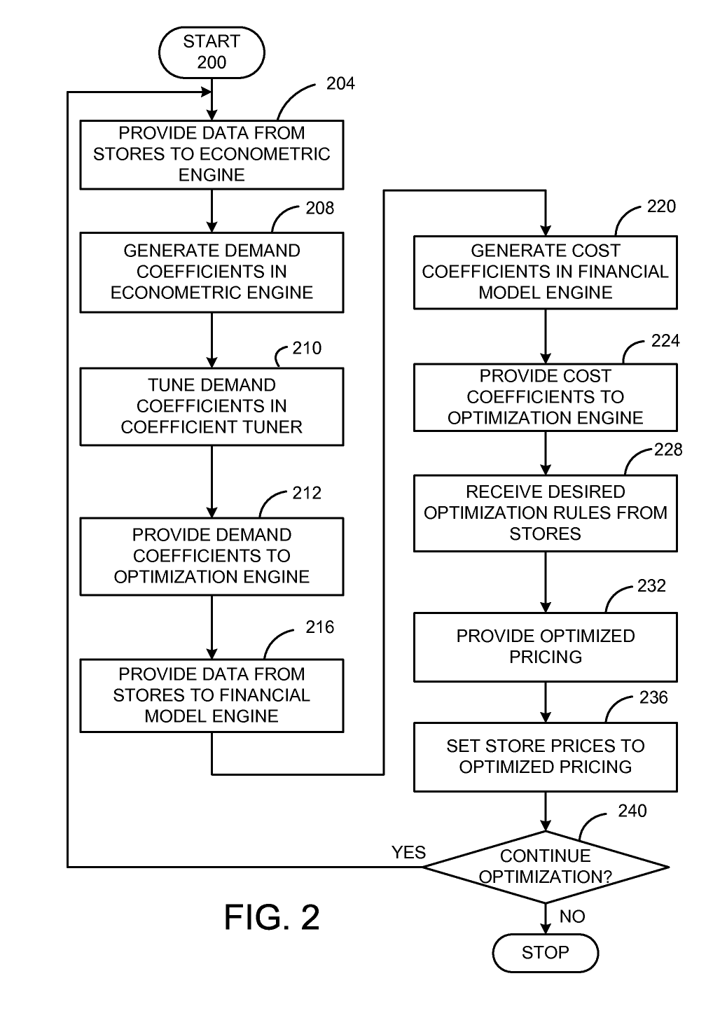

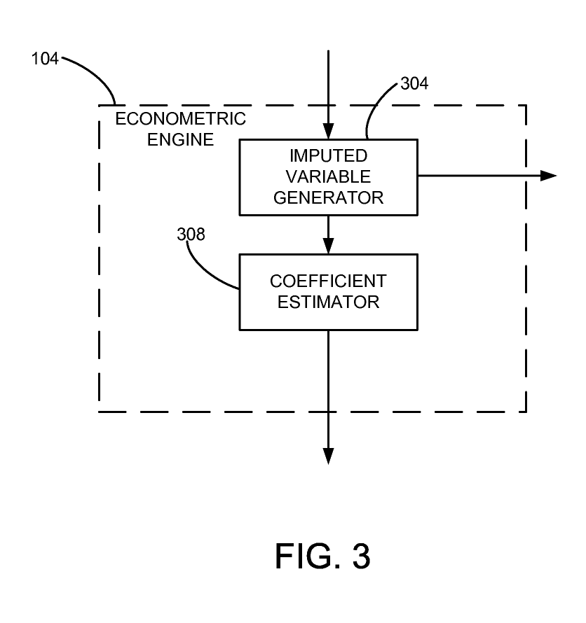

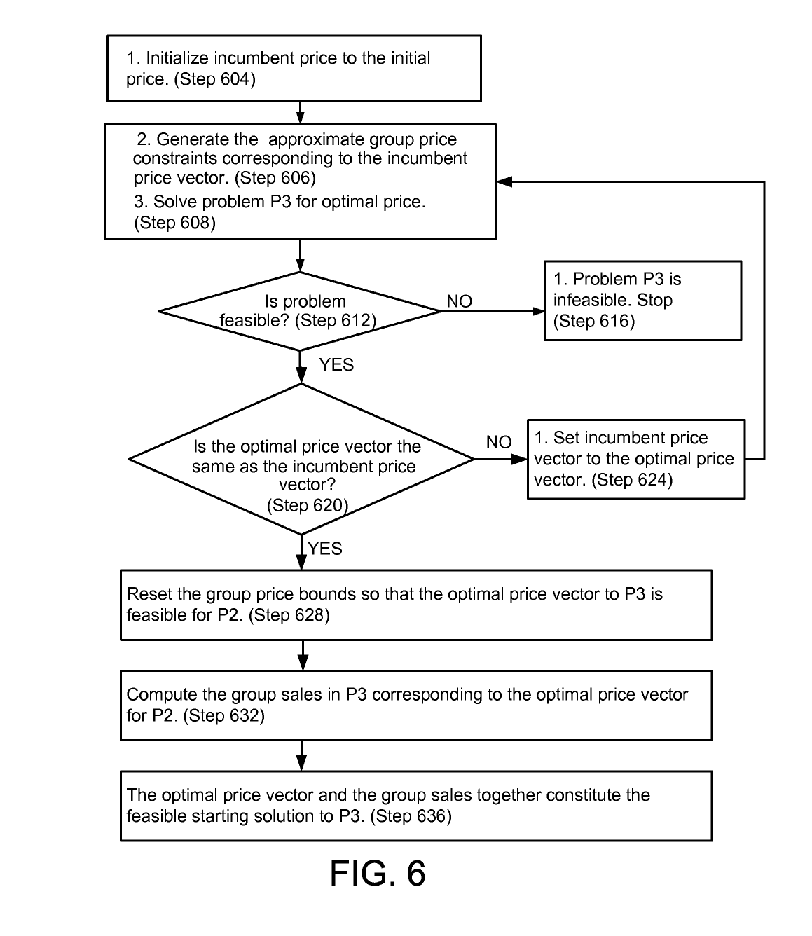

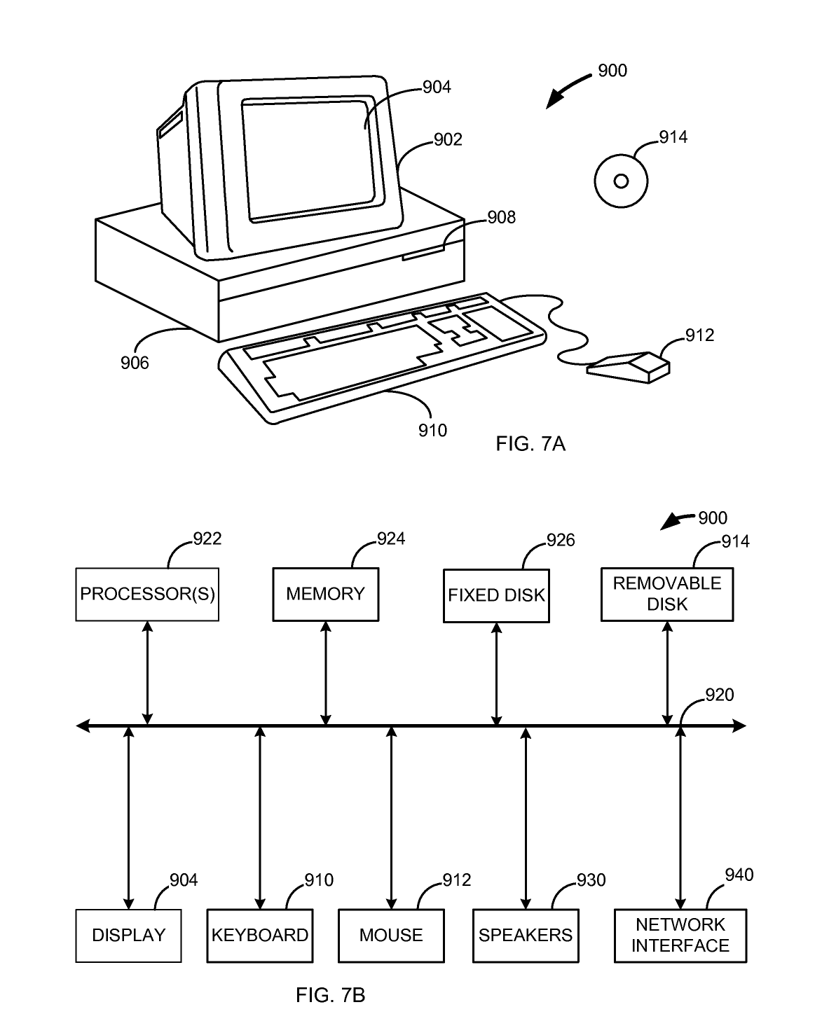

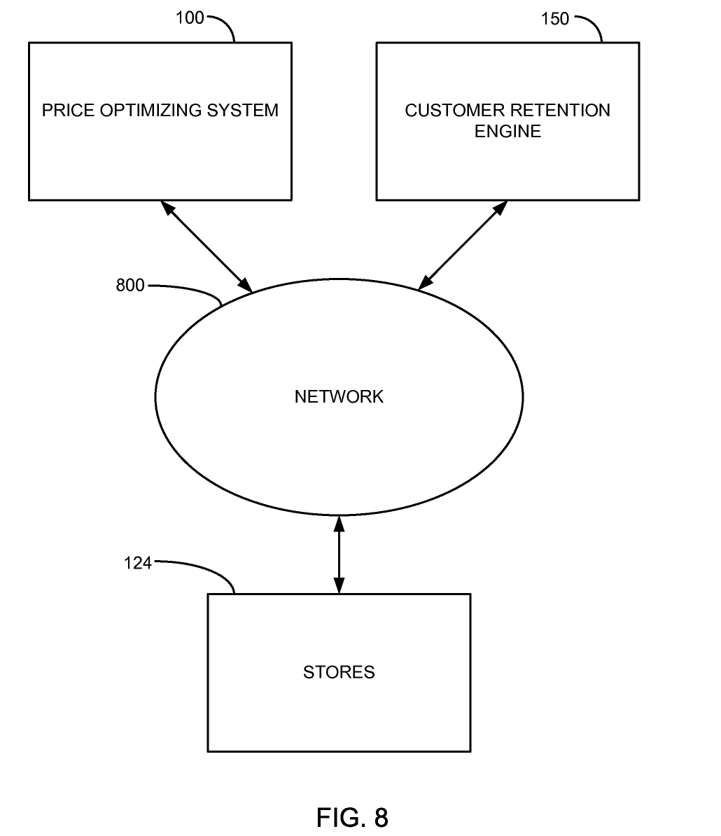

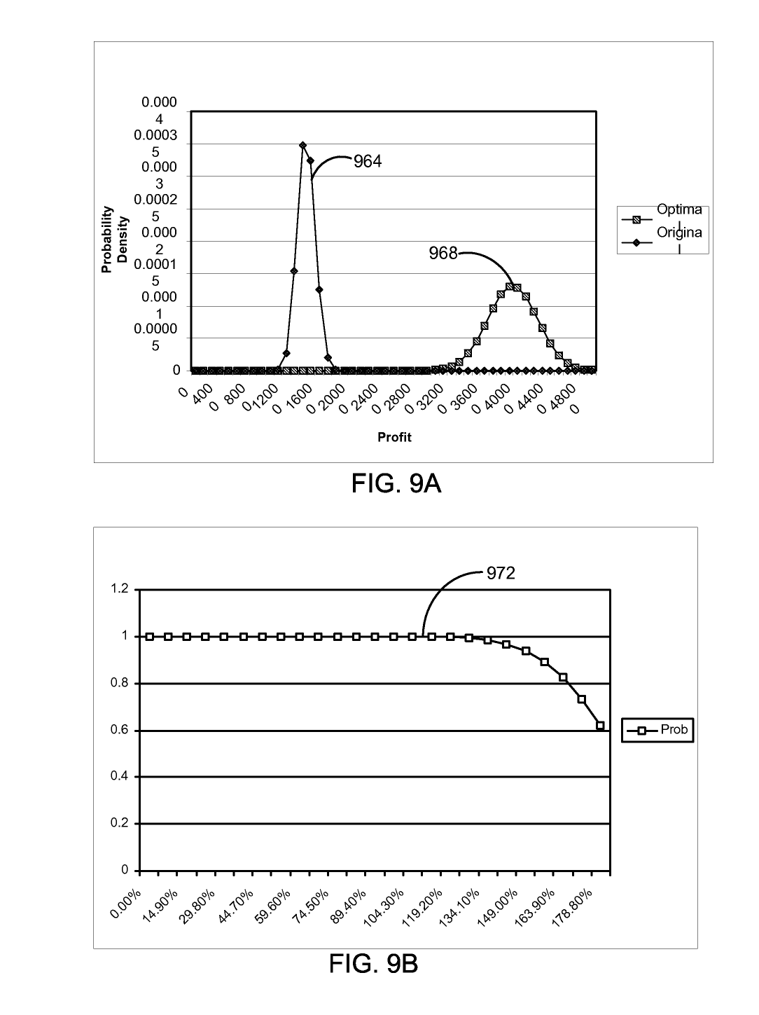

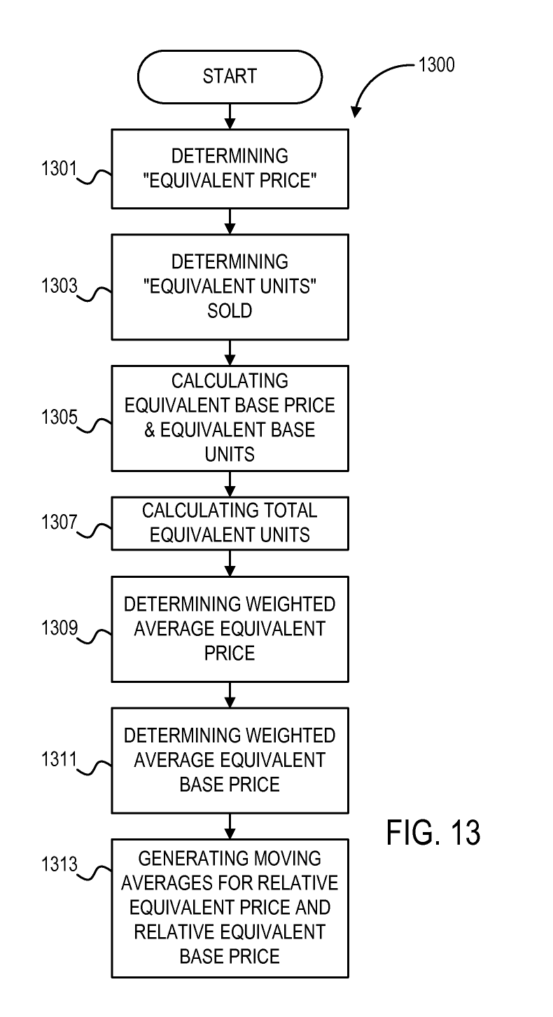

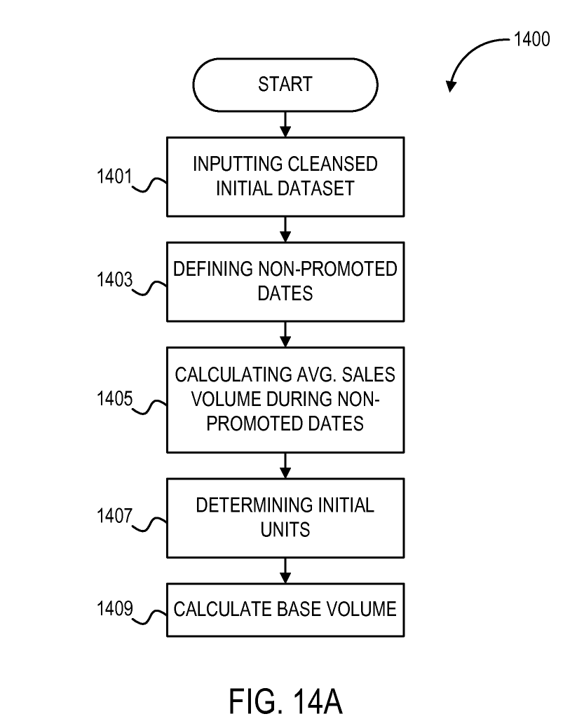

To facilitate discussion, FIGS. 1 and 2 show a coefficient tuning engine coupled to an optimization system and methods for such a system. FIGS. 3-6 illustrate the optimization system and methods in more detail. General computer systems for the optimization system may be seen at FIGS. 7 and 8. FIGS. 9 to 12D illustrate data error correction for optimization. FIGS. 13-20 show various pricing optimization processes.

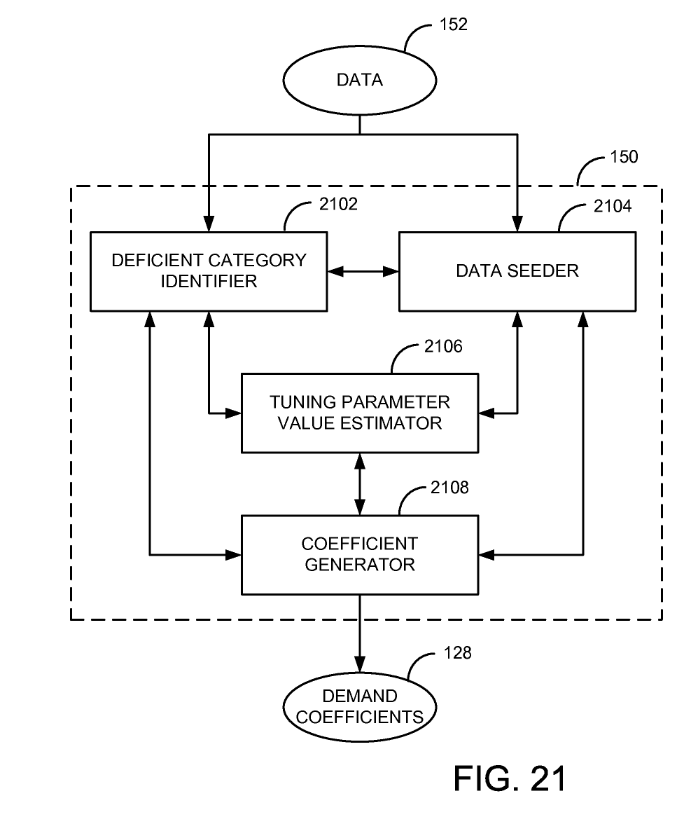

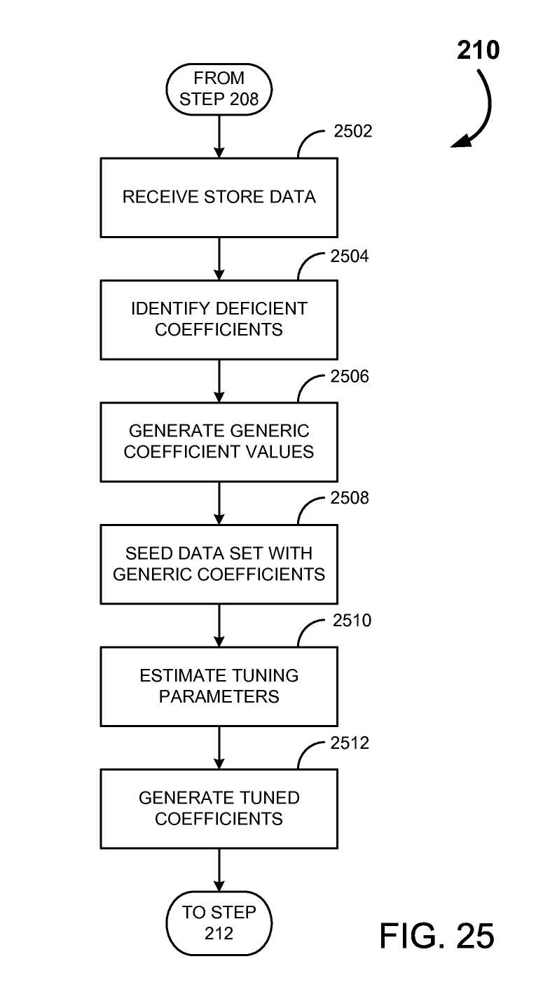

FIGS. 21 to 24 detail the coefficient tuning engine. Likewise, FIGS. 25 to 29 illustrate the method of generating tuned coefficients.

Although useful for generating tuned coefficients for virtually any reason, product or product category, the Coefficient Tuning Engine 150 described below demonstrates particular utility for generating tuned coefficients for products and product categories which have deficient historic pricing data. This is the case because the demand coefficients generated from sparse historic pricing data are susceptible to inaccuracies and ultimately have been linked to bad business decisions. Additionally, when coupled to an optimization system as illustrated at FIG. 1, the Coefficient Tuning Engine 150 may function as a particularly effective business tool.

The following description of some embodiments of the present invention will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Optimization System Overview

To facilitate discussion, FIG. 1 is a schematic view of a Price Optimizing System with Coefficient Tuning 100. The Price Optimizing System with Coefficient Tuning 100 comprises an Econometric Engine 104, a Financial Model Engine 108, an Optimization Engine 112, a Support Tool 116, and a Coefficient Tuning Engine 150. The Econometric Engine 104 is connected to the Optimization Engine 112, so that the output of the Econometric Engine 104 is an input of the Optimization Engine 112. The Financial Model Engine 108 is connected to the Optimization Engine 112, so that the output of the Financial Model Engine 108 is an input of the Optimization Engine 112. Likewise, the Coefficient Tuning Engine 150 is connected to the Optimization Engine 112, so that the output of the Coefficient Tuning Engine 150 is an input of the Optimization Engine 112. In some embodiments, the Coefficient Tuning Engine 150 may be an additional subunit of the Econometric Engine 104.

The Optimization Engine 112 is connected to the Support Tool 116 so that output of the Optimization Engine 112 is provided as input to the Support Tool 116 and output from the Support Tool 116 may be provided as input to the Optimization Engine 112. The Econometric Engine 104 may also exchange data with the Financial Model Engine 108.

FIG. 2 is a high level flowchart of a process that utilizes the Price Optimizing System with Coefficient Tuning 100. The operation of the Price Optimizing System with Coefficient Tuning 100 will be discussed in general here and in more detail further below. Data 120 is provided from the Stores 124 to the Econometric Engine 104 (step 204). Generally, the data 120 provided to the Econometric Engine 104 may be point-of-sale information, product information, and store information. The Econometric Engine 104 processes the data 120 to provide demand coefficients 128 (step 208) for a set of algebraic equations that may be used to estimate demand (volume sold) given certain marketing conditions (i.e., a particular store in the chain), including a price point. The demand coefficients 128 are provided to the Optimization Engine 112.

In some embodiments, the demand coefficients 128 may be further processed by the Coefficient Tuning Engine 150 prior to providing the demand coefficients 128 to the Optimization Engine 112 (step 210). Tuning of demand coefficients may include seeding data with generic values, selecting prior product categories for estimating tuning parameters and generation of tuned coefficients by maximizing a modified likelihood function. The likelihood function may be modified to include the estimated tuning parameters. Tuning of demand coefficients will be explained in more detail below in conjunction with FIGS. 25 to 29.

Additional processed data from the Econometric Engine 104 may also be provided to the Optimization Engine 112. The Financial Model Engine 108 may receive data 132 from the Stores 124 (step 216) and processed data from the Econometric Engine 104. The data 132 received from the stores is generally cost related data, such as average store labor rates, average distribution center labor rates, cost of capital, the average time it takes a cashier to scan an item (or unit) of product, how long it takes to stock a received unit of product and fixed cost data. The Financial Model Engine 108 may process the data to provide a variable cost and fixed cost for each unit of product in a store. The processing by the Econometric Engine 104 and the processing by the Financial Model Engine 108 may be done in parallel. Cost data 136 is provided from the Financial Model Engine 108 to the Optimization Engine 112 (step 224). The Optimization Engine 112 utilizes the demand coefficients 128 to create a demand equation. The optimization engine is able to forecast demand and cost for a set of prices to calculate net profit. The Stores 124 may use the Support Tool 116 to provide optimization rules to the Optimization Engine 112 (step 228).

The Optimization Engine 112 may use the demand equation, the variable and fixed costs and rules to compute an optimal set of prices that meet the rules (step 232). For example, if a rule specifies the maximization of profit, the optimization engine would find a set of prices that cause the largest difference between the total sales and the total cost of all products being measured. If a rule providing a promotion of one of the products by specifying a discounted price is provided, the optimization engine may provide a set of prices that allow for the promotion of the one product and the maximization of profit under that condition. In the specification and claims, the phrases “optimal set of prices” or “preferred set of prices” are defined as a set of computed prices for a set of products where the prices meet all of the rules. The rules normally include an optimization, such as optimizing profit or optimizing volume of sales of a product and constraints such as a limit in the variation of prices. The optimal (or preferred) set of prices is defined as prices that define a local optimum of an econometric model which lies within constraints specified by the rules When profit is maximized, it may be maximized for a sum of all measured products.

Such a maximization may not maximize profit for each individual product, but may instead have an ultimate objective of maximizing total profit. The optimal (preferred) set of prices may be sent from the Optimization Engine 112 to the Support Tool 116 so that the Stores 124 may use the user interface of the Support Tool 116 to obtain the optimal set of prices. Other methods may be used to provide the optimal set of prices to the Stores 124. The price of the products in the Stores 124 are set to the optimal set of prices (step 236), so that a maximization of profit or another objective is achieved.

Each component of the Price Optimizing System with Coefficient Tuning 100 will be discussed separately in more detail below.

### II. Econometric Engine

FIG. 3 is a more detailed view of the Econometric Engine 104. The econometric engine comprises an Imputed Variable Generator 304 and a Coefficient Estimator 308. In some embodiments, the Coefficient Tuning Engine 150 may likewise be a subunit of the Econometric Engine 104. In some alternate embodiments, the 150 may be considered separate from the Econometric Engine 104. The data 120 from the Stores 124 is provided to the Imputed Variable Generator 304. The data 120 may be raw data generated from cash register data, which may be generated by scanners used at the cash registers.

A. Imputed Variable Generator

The present invention provides methods, media, and systems for generating a plurality of imputed econometric variables. Such variables are useful in that they aid businesses in determining the effectiveness of a variety of sales strategies. In particular, such variables can be used to gauge the effects of various pricing or sales volume strategies.

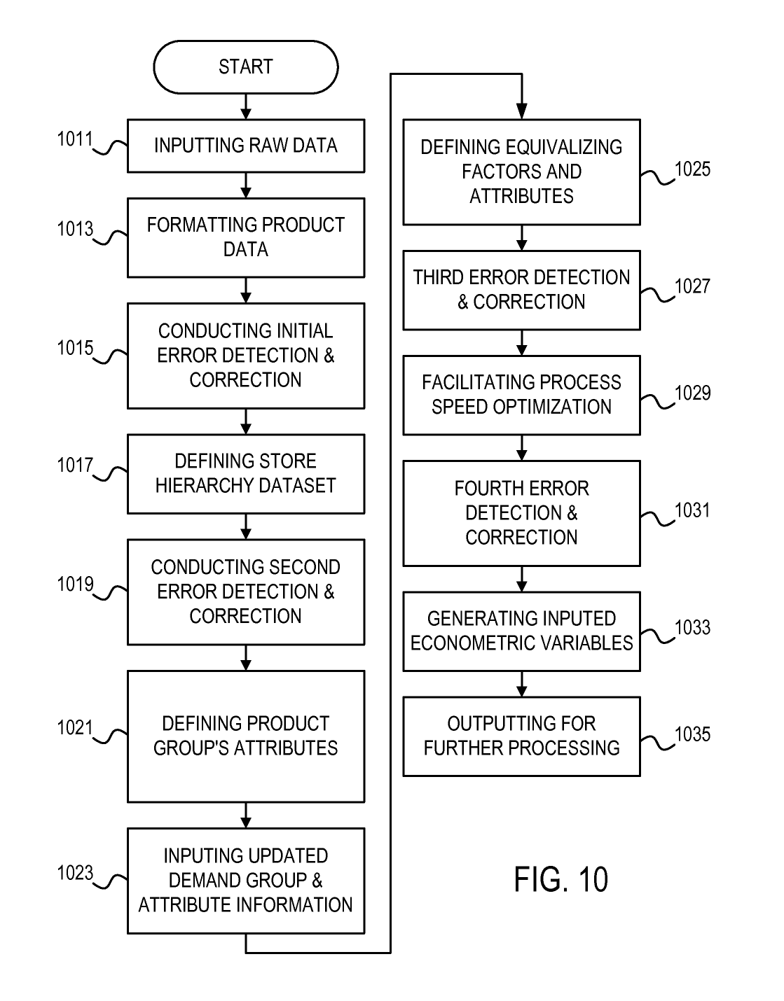

FIG. 10 illustrates a flowchart 1000 which describes steps of a method embodiment for data cleansing imputed econometric variable generation in accordance with the principles of the present invention. The process, generally described in FIG. 10, begins by initial dataset creation and data cleaning (Steps 1011-1031). This data set information is then used to generate imputed econometric variables (Step 1033) which can be output to and for other applications (Step 1035). Likewise, such dataset correction and cleansing

1. Initial Dataset Creation and Cleaning

The process of dataset creation and cleaning (that is to say the process of identifying incompatible data records and resolving the data incompatibility, also referred to herein as “error detection and correction”) begins by inputting raw econometric data (Step 1011). The raw econometric data is then subject to formatting and classifying by UPC designation (Step 1013). After formatting, the data is subject to an initial error detection and correction step (Step 1015). Once the econometric data has been corrected, the store information comprising part of the raw econometric data is used in defining a store data set hierarchy (Step 1017). This is followed by a second error detecting and correcting step (Step 1019). This is followed by defining a group of products which will comprise a demand group (i.e., a group of highly substitutable products) and be used for generating attribute information (Step 1021). Based on the defined demand group, the attribute information is updated (Step 1023). The data is equivalized and the demand group is further classified in accordance with size parameters (Step 1025). The demand group information is subjected to a third error detection and correction step (Step 1027). The demand group information is then manipulated to facilitate decreased process time (Step 1029). The data is then subjected to a fourth error detection and correction step (Step 1031), which generates an initial cleansed dataset. Using this initial cleansed dataset, imputed econometric variables are generated (Step 1033). Optionally, these imputed econometric variables may be output to other systems for further processing and analysis (Step 1035).

The process begins by inputting raw econometric data (Step 1011). The raw econometric data is provided by a client. The raw econometric data includes a variety of product information, including, but not limited to, the store from which the data is collected, the time period over which the data is collected, a UPC (Universal Product Code) for the product, and provide a UPC description of the product. Also, the raw econometric data must include product cost (e.g., the wholesale cost to the store), number of units sold, and either unit revenue or unit price. Also, the general category of product or department identification is input. A category is defined as a set of substitutable or complementary products, for example, “Italian Foods”. Such categorization can be proscribed by the client, or defined by generally accepted product categories. Additionally, such categorization can be accomplished using look-up tables or computer generated product categories.

Also, a more complete product descriptor is generated using the product information described above and, for example, a UPC description of the product and/or a product description found in some other look-up table (Step 1013).

The data is then subjected to a first error detection and correction process (Step 1015). Typically, this step includes the removal of all duplicate records and the removal of all records having no match in the client supplied data (typically scanner data).

Data subsets concerning store hierarchy are defined (Step 1017). This means stores are identified and categorized into various useful subsets. These subsets can be used to provide information concerning, among other things, regional or location specific economic effects.

The data is then subjected to a second error detection and correction process (Step 1019). This step cleans out certain obviously defective records. Examples include, but are not limited to, records displaying negative prices, negative sales volume, or negative cost. Records exhibiting unusual price information, determined through standard deviation or cross store comparisons, are also removed. This is followed by defining groups of products and their attributes and exporting this information to a supplementary file (e.g., a text file) (Step 1021). This product information can then be output into a separate process which can be used to define demand groups or product attributes. For example, this supplemental file can be input into a spreadsheet program (e.g., Excel®) which can use the product information to define “demand groups” (i.e., groups of highly substitutable products). Also, further product attribute information can be acquired and added to the supplementary file. In addition, updated demand group and attribute information can then be input as received (Step 1023). By maintaining a supplementary file containing large amounts of data, a more streamlined (abbreviated) dataset may be used in processing, thereby effectively speeding up processing time.

The data is further processed by defining an “equivalizing factor” for the products of each demand group in accordance with size and UOM parameters (Step 1025). This equivalizing factor can be provided by the client or imputed. An equivalizing factor can be imputed by using, for example, the median size for each UOM. Alternatively, some commonly used arbitrary value can be assigned. Once this information is gathered, all product prices and volume can be “equivalized”. Chiefly, the purpose of determining an equivalizing factor is to facilitate comparisons between different size products in a demand group.

The data is then subjected to a third error detection and correction process, which detects the effects of closed stores and certain other erroneous records (Step 1027). In accord with the principles of the invention, stores that demonstrate no product movement (product sales equal to zero) over a predetermined time period are treated as closed. Those stores and their records are dropped from the process. The third error detection and correction also includes analysis tools for detecting the presence of erroneous duplicate records. A further correction can be made for records having the same date and causal value but have differing prices or differing number of units sold.

After all the duplicate records eliminated, the data is reconstructed. The data can be reviewed again to insure all duplicates are removed. Optionally, an output file including all discrepancies can be produced. In the event that it becomes necessary, this output file can be used as a follow-up record for consulting with the client to confirm the accuracy of the error detection and correction process.

Additionally, reduced processing times may be achieved by reformatting the data (Step 1029). For example, groups of related low sales volume products (frequently high priced items) can optionally be aggregated as a single product and processed together. Additionally, the data may be split into conveniently sized data subsets defined by a store or groups of stores which are then processed together to shorten the processing times.

Next the process includes determining the nature of missing data records in a fourth error detection and correction step (Step 1031). The missing data records are analyzed again before finally outputting a cleansed initial dataset. For example, data collected over a modeled time interval is analyzed by introducing the data into a data grid divided into a set of time periods. For the time periods having no records, a determination must be made. Is the record missing because:

a. there were no sales that product during that week (time period);

b. the product was sold out and no stock was present in the store during that time period (this situation is also referred to herein as a “stock-out”);

c. the absence of data is due to a processing error.

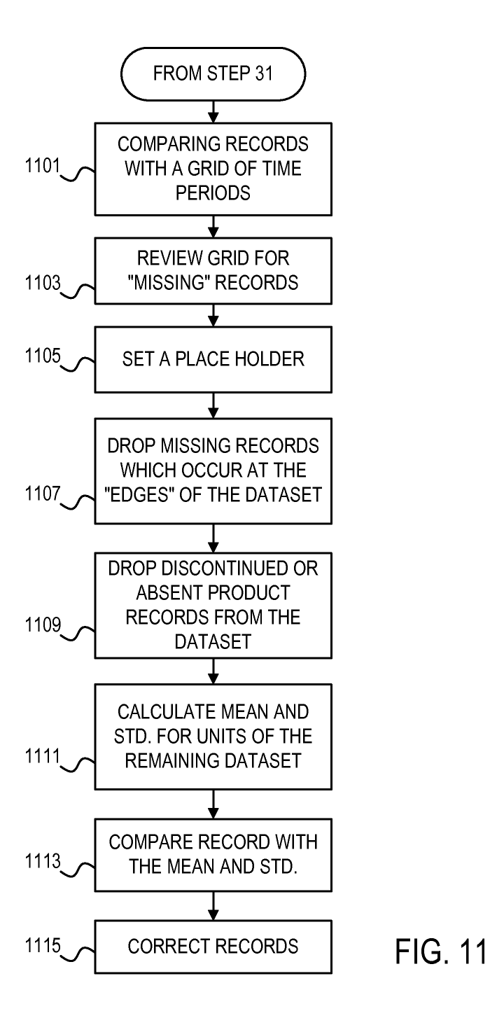

FIG. 11 depicts a process flow embodiment for determining the nature of missing data records in a fourth error detection and correction step in accordance with the principles of the present invention. The records are compared to a grid of time periods (Step 1101). The grid is reviewed for missing records with respect to a particular store and product (Step 1103). These missing records are then marked with a placeholder (Step 1105). Missing records at the “edges” of the dataset do not significantly affect the dataset and are deleted (Step 1107). Records for discontinued products or products recently introduced are dropped for those time periods where the product was not carried in the Store (Step 1109). The remaining dataset is processed to determine an average value for units (sold) and a STD for units (Step 1111). Each missing record is compared to the average units (Step 1113) and based on this comparison, a correction can be made (Step 1115).

If the first or last grid in the dataset has few or no observations, those records are deleted from the dataset (Step 1107). For purposes of the above analysis, a grid having “few” observations is defined as a grid having 50% fewer observations than is normal for the grids in the middle of the dataset. Also, using client-supplied stocking information, products which have been discontinued during the modeled time interval do not have their grids filled out for the discontinued time period (Step 1109). Also, products which are introduced during the modeled time interval have their time grid filled out only for those time periods occurring after the product introduction date. Thus, certain data aberrations are removed from the modeled dataset, permitting more accurate modeling.

The mean units (sold) and the STD for units are then calculated (Step 1111). The missing record is then compared with the mean value to determine if the actual value is feasible (Step 1113). This comparison may then correct for “stock-out”.

The product histories of the dataset can also be examined. If the subject product was introduced or discontinued as a salable item at the subject store during the modeled time interval, the grid is not filled out (with either zero or average values) for those time periods where the product was not offered for sale in the subject store. In this way missing records do not corrupt the dataset.

Further aspects of the fourth error detection and correction include a detection and elimination of outlying price data points (outliers). An exemplary way of accomplishing this compares the number of standard deviations the record lies from the mean price for each product within a given store, as determined over the modeled time interval. Outliers may be assigned adjusted prices. The adjusted prices may have the value of the immediately preceding time period (e.g., the previous day's or week's price for that product within the store). This adjusted price data is again checked for outliers (using the original mean and STD). The process may optionally continue, iteratively, until there are no further outliers.

The net result of execution of the process Steps 1011-1031 disclosed hereinabove is the generation of a cleansed initial dataset which can be used for its own purpose or input into other econometric processes. One such process is the generation of imputed econometric variables.

2. Generation of Imputed Econometric Variables

The foregoing steps (1011-1031) concern cleansing the raw econometric data to create an error detected and error corrected (“cleansed”) initial dataset. The cleansed initial dataset created in the foregoing steps can now be used to generate a variety of useful imputed econometric variables (Step 1033). These imputed econometric variables are useful in their own right and may also be output for use in further processing (Step 1035). One particularly useful application of the imputed econometric variables is that they can be input into an optimization engine which collects data input from a variety of sources and processes the data to provide very accurate economic modeling information.

A. Imputed Base Price

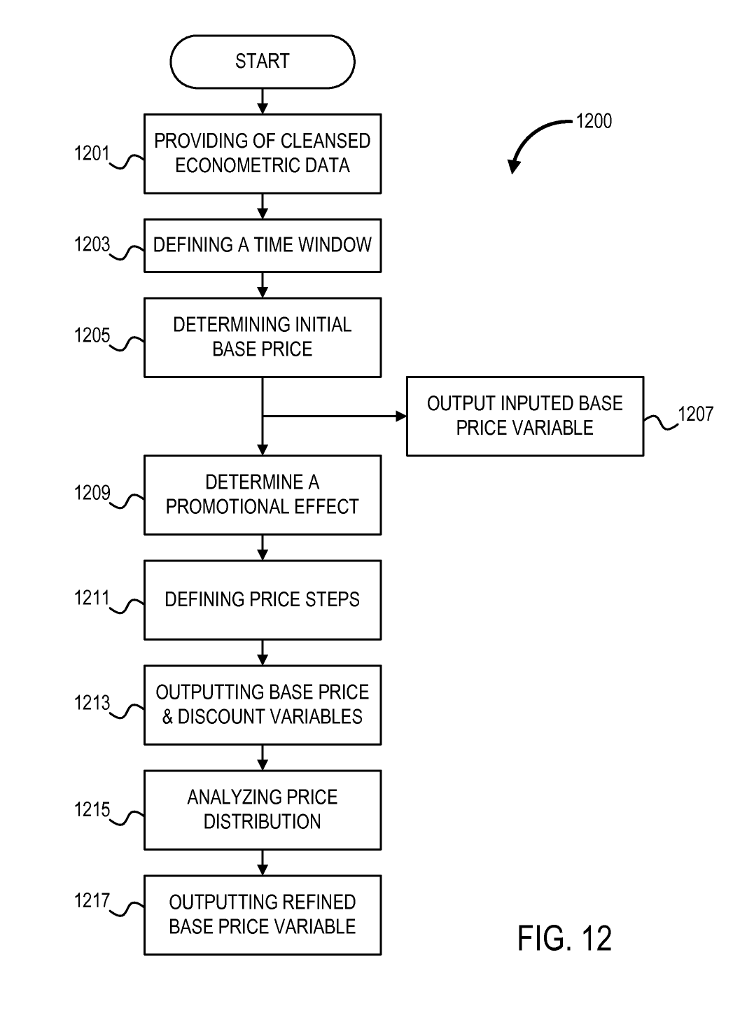

One imputed econometric variable that can be determined using the initial dataset created in accordance with the forgoing, is an imputed base price variable (or base price). FIG. 12 is a flowchart 1200 outlining one embodiment for determining the imputed base price variable. The process begins by providing the process 1200 with a “cleansed” initial dataset (Step 1201), for example, the initial dataset created as described in Steps 1011-1031 of FIG. 10. The initial dataset is examined over a defined time window (Step 1203). Defining a time window (Step 1203) includes choosing an amount of time which frames a selected data point allowing one to look forward and backward in time from the selected data point which lies at the midpoint in the time window. This is done for each data point in the dataset, with the time window being defined for each selected data point. The time frame can be user selected or computer selected.

Once the time window is defined, an “initial base price” is determined (Step 1205). This can be accomplished by any number of ways, including maxima comparisons or averages.

The initial base price values generated above provide satisfactory values for the imputed base price variable which may be output (Step 1207) and used for most purposes. However, optional Steps 1209-1217 describe an approach for generating a more refined imputed base price variable.

In generating a more refined imputed base price variable, the effect of promotional (or discount) pricing is addressed (Steps 1209-1217). This may be calculated by specifying a discount criteria (Step 1209); defining price steps (Step 1211); outputting an imputed base price variable and an imputed discount variable (Step 1213); analyzing the base price distribution (Step 1215); and outputting a refined base price variable (Step 1217).

Data records are evaluated over a series of time periods (e.g., weeks) and evaluated. The point is to identify price records which are discounted below a base price. By identifying these prices and not including them in a calculation of base price, the base price calculation will be more accurate. Therefore, a discount criterion is defined and input as a variable (Step 1209).

Further analysis is used to define base price “steps” (Step 1211). Base price data points are evaluated. Steps are roughly defined such that the base price data points lie within a small percent of distance from the step to which they are associated (e.g., 2%). This can be accomplished using, for example, a simple regression analysis such as is known to those having ordinary skill in the art. By defining the steps, the average value for base price over the step is determined. Also, price data points are averaged to determine the base price of step. Thus, the average of the base prices in a step is treated as the refined base price for that step.

Further refining includes an analysis of the first step. If the first step is short (along the time axis) and considerably lower than the next step, it is assumed that the first step is based on a discounted price point. As such, the value of the next step is treated as the base price for the time period of the first step.

At this point, absolute discount (ΔP) and base price (BP) are used to calculate percent discount (ΔP/BP) for each store product time period.

This base price is subjected to further analysis for accuracy using cross-store checking (Step 1215). This can be accomplished by analyzing the base price data for each product within a given store, and comparing with all other stores. Any outlier store's base price is adjusted for the analyzed product such that it lies closer to an average cross-store percentile for base price over all stores.

Thus, the forgoing process illustrates an embodiment for determining an imputed base price variable.

B. Imputed Relative Price Variable

Reference is now made to the flowchart 1300 of FIG. 13 which illustrates an embodiment for generating relative price variables in accordance with the principles of the present invention. A relative price may be calculated. As disclosed earlier, an equivalizing factor is defined. Using the equivalizing factor, an equivalent price can be calculated (Step 1301). Next equivalent units sold (“units”) can be calculated (Step 1303). In a similar vein, equivalent base price and equivalent base units are calculated (Step 1305) using the imputed values for base price (for example, as determined in Steps 1201-1207) and for base units (also referred to as base volume which is determined as disclosed below). For each Store, each demand group, and each date, the total equivalent units is determined (Step 1307). A weighted calculation of relative equivalent price is then made (Step 1309).

For example, such relative price value is determined as follows: equivalent price is divided by a weighted denominator, the weighted denominator is calculated by multiplying equivalent units for each product times the equivalent units sold. For each product, only the values of other products are used in the calculation. This means excluding the product being analyzed. For example, the relative price of A, given three exemplary products A, B and C, is determined as follows:

$${rel}_{A} = \frac{equiv . priceofA}{[ \frac{\begin{matrix}( equiv . unitsofB ) ( Equiv . priceofB ) + \\ ( equiv . unitsofC ) ( equiv . priceofC )\end{matrix}}{\begin{matrix}totalequivalentunits - \\ equivalentunitsofA\end{matrix}} ]}$$

Also, a weighted average equivalent base price is calculated using the method disclosed hereinabove. The only difference being that instead of using the actual equivalent price, the calculated base price values per equivalent are used (Step 1311). Using the previously disclosed techniques, a moving average is generated for relative actual equivalent price and relative equivalent base price (Step 1313). Thus a variety of imputed relative price variables can be generated (e.g., relative equivalent price, relative equivalent base price, etc.).

C. Imputed Base Volume Variable

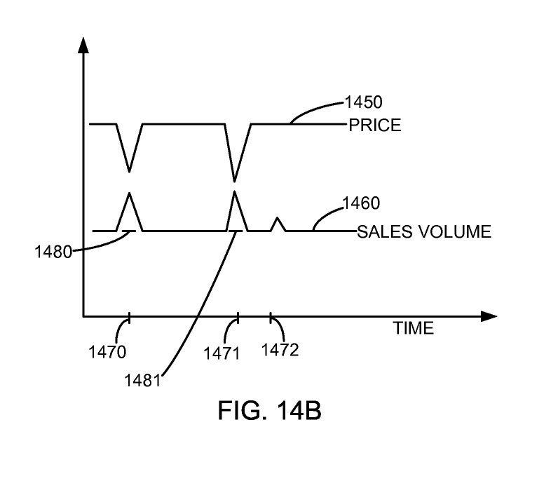

A flowchart 1400 shown in FIG. 14A illustrates one embodiment for generating an imputed base volume variable. Base volume refers to the volume of product units sold in the absence of discount pricing or other promotional effects. Base volume is also referred to herein as simply “base units”. The determination of base volume begins by receiving the cleansed initial dataset information for each product and store (Step 1401). The initial dataset information is processed to determine “non-promoted dates” (Step 1403), i.e., dates where the products are not significantly price discounted. Using the non-promoted data subset, an average value for “units” and a STD is calculated (i.e., an average value for product unit sales volume for each product during the non-promoted dates is calculated) (Step 1405). This value shall be referred to as the “non-promoted average units”. An initial value for base units (“initial base units”) is now determined (Step 1407).

This principle can be more readily understood with reference to FIG. 14B. The price behavior 1450 can be compared with sales behavior 1460. Typically, when the price drops below a certain level, sales volume increases. This can be seen at time periods 1470, 1471. In such a case, the actual units sold (more than usual) are not included in a base volume determination. Rather, those records are replaced with the average volume value for the non-promoted dates (the non-promoted average unit value, shown with the dotted lines 1480, 1481). However, where a sales volume increases during a period of negligible discount (e.g., less than 2%), such as shown for time period 1472, the actual units sold (actual sales volume) are used in the calculation of base volume. However, if the records show a sales volume increase 1472 which is too large (e.g., greater than 1.5 standard deviations from the non-promoted average unit value), it is assumed that some other factor besides price is influencing unit volume and the actual unit value is not used for initial base units but is replaced by the non-promoted average unit value.

A calculated base volume value is now determined (Step 1409). This is accomplished by defining a time window. For each store and product, the average value of “initial base units” is calculated for each time window. This value is referred to as “average base units”. This value is calculated for a series of time windows to generate a moving average of “average base units”. This moving average of the average base units over the modeled time interval is defined as the “base volume variable”.

D. Supplementary Error Detection and Correction

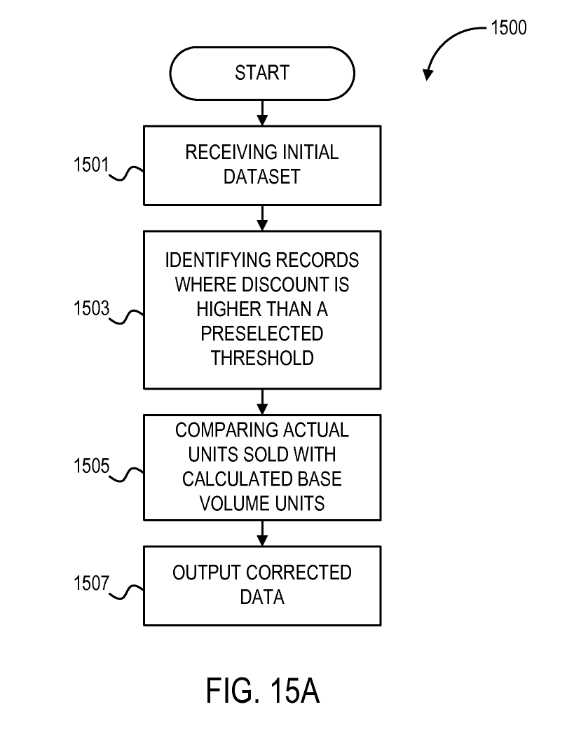

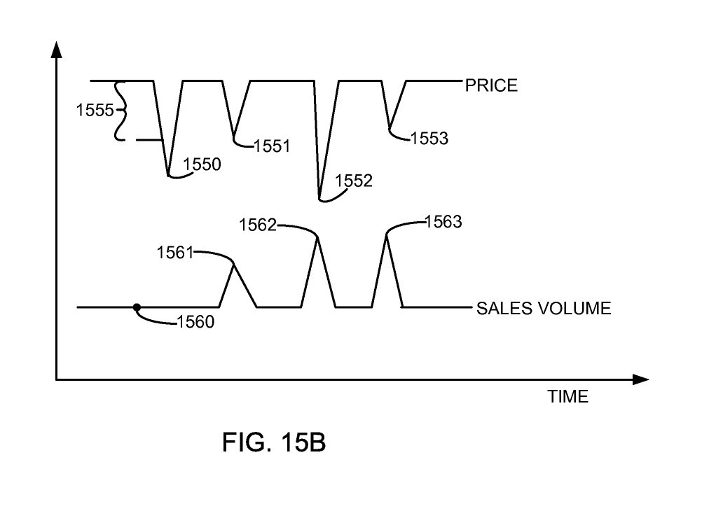

Based on previously determined discount information, supplementary error detection and correction may be used to correct price outliers. A flowchart 1500 illustrated in FIG. 15A shows one embodiment for accomplishing such supplementary error detection and correction. Such correction begins by receiving the cleansed initial dataset information for each product and store (Step 1501). In addition the previously calculated discount information is also input, or alternatively, the discount information (e.g., ΔP/BP) can be calculated as needed. The initial dataset and discount information is processed to identify discounts higher than a preselected threshold (e.g., 60% discount) (Step 1503). For those time periods (e.g., weeks) having price discounts higher than the preselected threshold (e.g., greater than 60%), a comparison of actual units sold to calculated base volume units (as calculated above) is made (Step 1505).

The concepts are similar to that illustrated in FIG. 14B and may be more easily illustrated with reference to FIG. 15B. The principles of this aspect of the present invention are directed toward finding unexplained price aberrations. For example, referring to FIG. 15B, price discounts are depicted at data points 1550, 1551, 1552, and 1553. Also, corresponding sales increases are depicted by at data points 1561, 1562, and 1563. The data point 1550 has a discount greater than the threshold 1555 (e.g., 60%). So an analysis is made of data point 1550.

E. Determining Imputed Variables which Correct for the Effect of Consumer Stockpiling

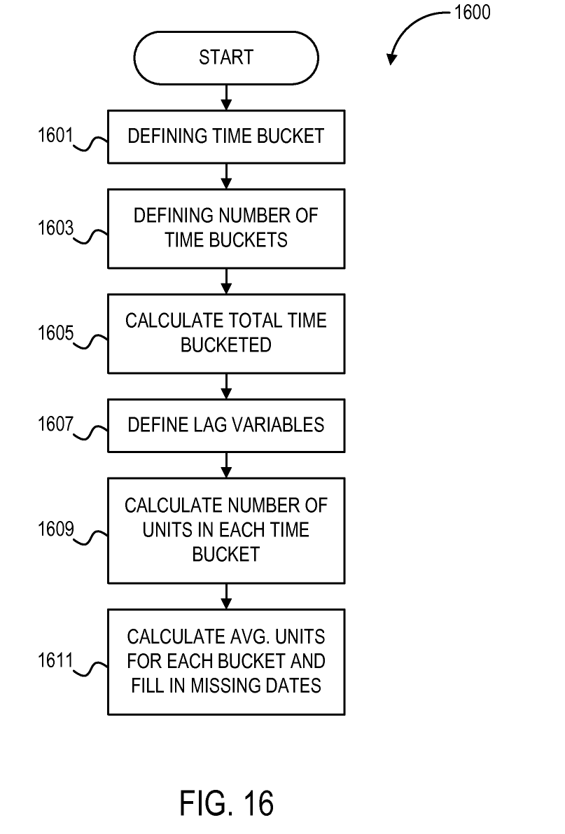

With reference to FIG. 16, a flowchart 1600 illustrating a method embodiment for generating stockpiling variables is depicted. The pictured embodiment 1600 begins by defining the size of a “time bucket” (m), for example, the size (m) of the bucket can be measured in days (Step 1601). Additionally, the number (τ) of time buckets to be used is also defined (Step 1603). The total amount of time “bucketed” (m×τ) is calculated (Step 1605).

“Lag” variables which define the number of product units sold (“units”) in the time leading up to the analyzed date are defined (Step 1607). Then the total number of product units sold is calculated for each defined time bucket (Step 1609). Correction can be made at the “front end” of the modeled time interval.

If working near the front end of a dataset, units from previous weeks cannot always be defined and in their place an averaged value for bucket sum can be used (Step 1611). The idea is to detect and integrate the effects of consumer stockpiling on into a predictive sales model.

F. Day of the Week Analysis

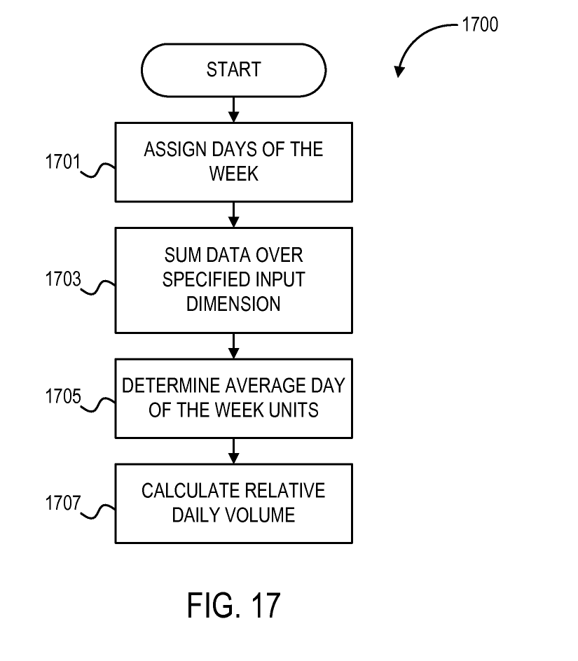

With reference to FIG. 17, a flowchart 1700 illustrating one embodiment for determining a Day of the Week variable is shown. It is necessary to have data on a daily basis for a determination of Day of the Week effects. In accordance with the principles of the present invention, the embodiment begins by assigning the days of the week numerical values (Step 1701). Once categorized by day of the week, the product units (sold) are summed for a specified dimension or set of dimensions. Dimension as used herein means a specified input variable including, but not limited to, Product, Brand, Demand Group, Store, Region, Store Format, and other input variable which may yield useful information (Step 1703). For each Day of Week and each dimension specified, the average units (sold) are determined (Step 1705). For each date, a “relative daily volume” variable is also determined (Step 1707). This information may prove valuable to a client merchant and can comprise an input variable for other econometric models.

G. Imputed Seasonality Variable Generation

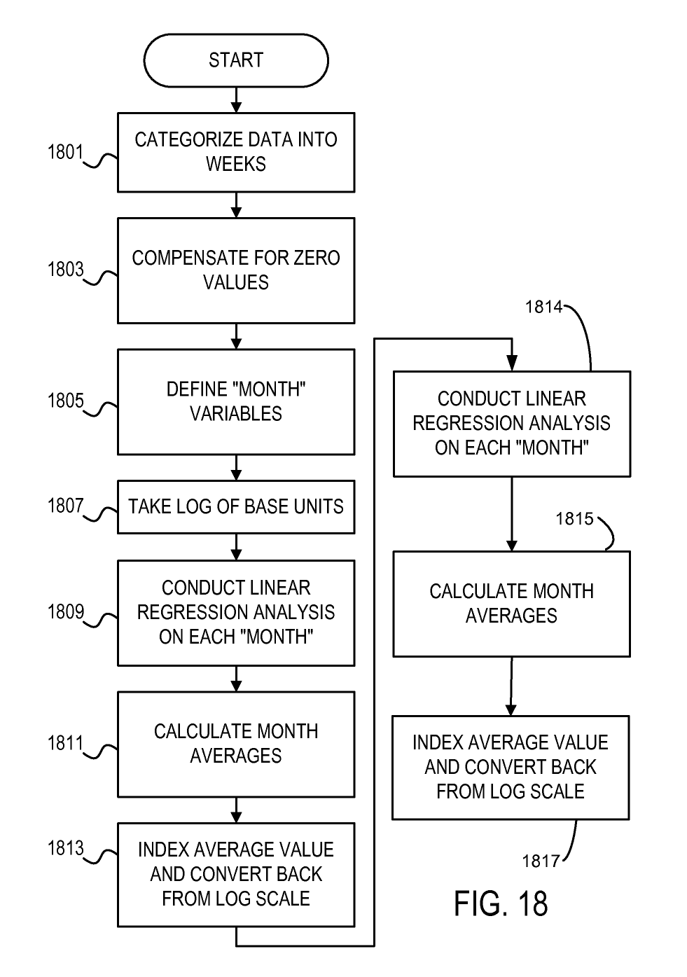

Another useful imputed variable is an imputed seasonality variable for determining seasonal variations in sales volume. Referring to FIG. 18, a flowchart 1800 illustrating one embodiment in accordance with the present invention for determining an imputed seasonality variable is shown. The process begins with categorizing the data into weekly data records, if necessary (Step 1801). Zero values and missing records are then compensated for (Step 1803). “Month” variables are then defined (Step 1805). A logarithm of base units is then taken (Step 1807). Linear regressions are performed on each “Month” (Step 1809). “Months” are averaged over a specified dimension (Step 1811). Indexes are averaged and converted back from log scale to original scale (Step 1813). The average of normalized estimates are calculated and used as Seasonality index (Step 1815). Individual holidays are estimated and exported as imputed seasonality variables (Step 1817).

H. Imputed Promotional Variable

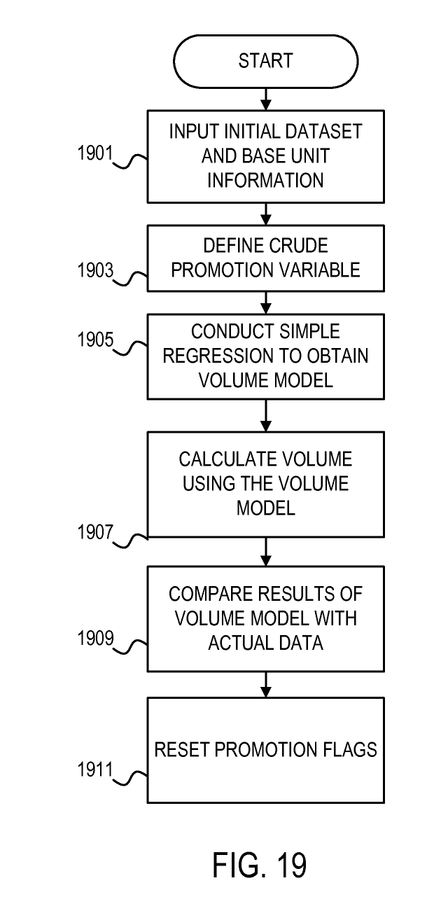

Another useful variable is a variable which can predict promotional effects. FIG. 19 provides a flowchart illustrating an embodiment enabling the generation of imputed promotional variables in accordance with the principles of the present invention. Such a variable can be imputed using actual pricing information, actual product unit sales data, and calculated value for average base units (as calculated above). This leads to a calculation of an imputed promotional variable which takes into consideration the entire range of promotional effects.

Referring back to FIG. 19, the process begins by inputting the cleansed initial dataset and the calculated average base units information (Step 1901). A crude promotional variable is then determined (Step 1903). Such a crude promotional variable can be defined using promotion flags. A simple regression analysis, as is known to those having ordinary skill in the art, (e.g., a mixed effects regression) is run on sales volume to obtain a model for predicting sales volume (Step 1905). Using the model, a sample calculation of sales volume is performed (Step 1907). The results of the model are compared with the actual sales data to further refine the promotion flags (Step 1909). If the sales volume is underpredicted (by the model) by greater than some selected percentage (e.g., 30-50%), the promotion flag may be set to reflect the effects of a probable non-discount promotional effect. Since the remaining modeled results more closely approximate actual sales behavior, the promotion flags for those results are not reset (Step 1911). The newly defined promotion flags are incorporated into a new model for defining the imputed promotional variable.

I. Imputed Cross-Elasticity Variable

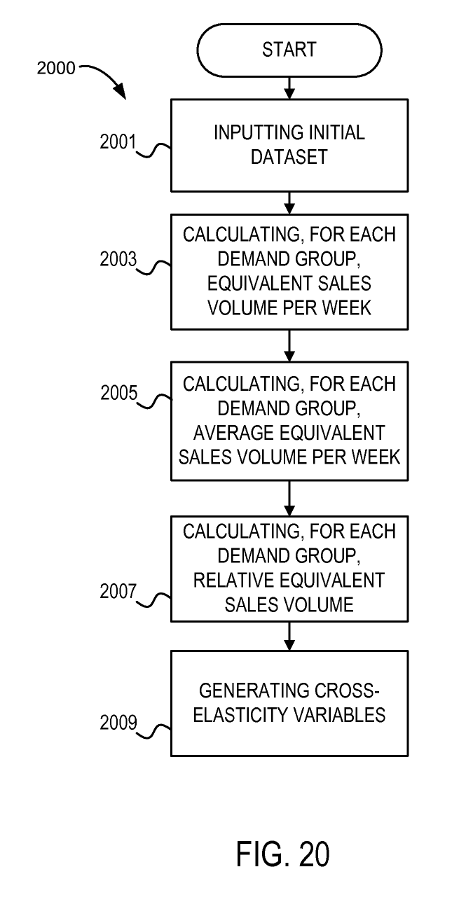

Another useful variable is a cross-elasticity variable. FIG. 20 depicts a flowchart 2000 which illustrates the generation of cross-elasticity variables in accordance with the principles of the present invention. The generation of an imputed cross-elasticity variable allows the analysis of the effects of a demand group on other demand groups within the same category. Here, a category describes a group of related demand groups which encompass highly substitutable products and complementary products. Typical examples of categories are, among many others, Italian foods, breakfast foods, or soft drinks.

The initial dataset information is input into the system (Step 2001). For each demand group, the total equivalent sales volume for each store is calculated for each time period (for purposes of this illustration the time period is a week) during the modeled time interval (Step 2003). For each week and each demand group, the average total equivalent sales volume for each store is calculated for each week over the modeled time interval (Step 2005). For each demand group, the relative equivalent sales volume for each store is calculated for each week (Step 2007). The relative demand group equivalent sales volume for the other demand groups is quantified and treated as a variable in the calculation of sales volume of the first demand group, thereby generating cross-elasticity variables (Step 2009).

The calculated imputed variables and data are outputted from the Imputed Variable Generator 304 to the Coefficient Estimator 308. Some of the imputed variables may also be provided to the Financial Model Engine 108.

B. Coefficient Estimator

The Coefficient Estimator 308 uses the imputed variables and data to estimate coefficients, which may be used in an equation to predict demand. In a preferred embodiment of the invention, sales for a demand group (S) is calculated and a market share (F) for a particular product is calculated, so that demand (D) for a particular product is estimated by D=S·F. A demand group is defined as a collection of highly substitutable products. In the preferred embodiments, the imputed variables and equations for sales (S) of a demand group and market share (F) are as follows:

1. Modeling Framework

The econometric modeling engine uses one or more of statistical techniques, including, but not limited to, linear and non-linear regressions, hierarchical regressions, mixed-effect models, Bayesian techniques incorporating priors, and machine learning techniques. Mixed-effect models are more robust with regards to missing or insufficient data. Further, mixed-effect models allows for a framework of sharing information across various subjects in the model, enabling better estimates. Bayesian techniques with prior information can incorporate all the features of the mixed effect models and, in addition, also enable for guiding the allowable values of the coefficients based upon existing information.

2. Terminology

The equivalent price of a product is defined as the price of a standardized unit of measure, which may be calculated based on the product description and the spread of sizes/counts that apply to that description. Each individual product price is divided by this standardized unit of measure to obtain the equivalent price.

A demand group is defined as a set of products that are substitutes or near substitutes for each other. A product can belong to only one demand group. A product category consists of one or more demand groups. For this example, attention is restricted to a single category consisting of multiple demand groups.

Both models:

Subscript i: Demand group (primary). A demand group is a collection of highly substitutable products.

Subscript j: Demand group (secondary). A secondary demand group is another demand group in the same category as the primary demand group, where a category is defined as a collection of substitutable or complementary products.

Subscript k: Product, where products are items with common UPC numbers.

Subscript t: Time period, which may be days, weeks, or hours.

Subscript B: Baseline, which is a state of product if there was no promotion.

Subscript n: Number of time periods away from current time period.

ε: Error term for regression equations, with appropriate subscripts per context.

3. Stage 1 (Sales) Model

A. Sales Model Multipliers (Data Values, or Covariates) and Dependent Variables

S_{i,t}: The equivalent sales of demand group i in period t in store s in dollars. Equivalent sales may be defined as sales of equivalent units of products being compared.

S_{Bi,t}: The equivalent baseline sales of demand group i in store s in period t.

S̅_{i,t}: The equivalent sales of demand group i in store s averaged over periods leading up to period t.

R_{i,t}: The equivalent revenue of demand group i in period t.

R_{Bi,t}: The equivalent baseline revenue of demand group i in period t, which would be baseline sales times the baseline price.

R̅_{i,t}: The equivalent revenue of demand group i averaged over periods leading up to period t.

P_{i,t}: The equivalent price of demand group i at store s in time period t, calculated as total equivalent revenue of demand group i divided by total equivalent sales in the period (S_{i,t}/R_{i,t}), and where the equivalent price is the price of an equivalent unit, such as a price per ounce.

P̅_{i,t}: The average equivalent price of demand group i in store s for time period t, calculated as average total equivalent revenue of demand group i divided by average total equivalent sales ( S̅_{i,t}/ R̅_{i,t}).

P̅_{i,t}: The average competitor (e.g. a competing store in the area) equivalent price of demand group i in store s for time period t, calculated as average competitor total equivalent revenue of demand group i divided by average competitor total equivalent sales.

M_{i,t}: The promotion level for demand group i in store s in period t.

X_{i,t}: The seasonality index for demand group i in store s in period t.

TSₜ: The total dollar sales for the entire store in period t, computed using historical data.

T S̅ₜ: The total dollar sales for the region in period t, computed using historical data. A region would be a grouping of stores possibly in a certain geographical area.

B. Sales Model Factors (Parameters to be Estimated)

γᵢ: The price elasticity factor for demand group i measured with respect to the deviations of the weighted average price of the demand group from the past weighted average price of the group. It measures the sensitivity of sales of equivalized units of the demand group with respect to the group price.

νᵢ: The promotion factor for demand group i. This factor measures the sensitivity of the equivalent sales of the demand group to the general promotion level of the group.

ψᵢ: The seasonality factor for demand group i. This factor measures the sensitivity of the equivalent sales of the demand group to seasonality.

κᵢ: The seasonality-price interaction factor that measures the interaction of weighted average price deviations and seasonality for demand group i. The seasonality and the group price may interact with each other in a nonlinear way. This factor measures a degree of nonlinearity.

δ_{i,n}: The time lag factor for demand group i and delay of n weeks. The time lag factor measures the level of forward buying or stockpiling activity by customers. Note that this is the only factor that is estimated at the demand group level rather than the store-demand group level.

φ_{i,j}: The cross elasticity factor for demand group i and demand group j. This factor measures how sales of a demand group are affected by the sales of other demand groups in the same category.

η_{i,t}: The competitive price factor for demand group i measured with respect to the difference between the weighted average price of the demand group within the store and outside competitors. This factor measures the effect of competitive activity on the sales of products in a given demand group.

πᵢ: The traffic factor for demand group i. Sales may be affected by the overall traffic through a store. This factor quantifies the relationship.

θᵢ: The day-of-week (DOW) effect for demand group i. Each day of a week could have a different sales pattern. This factor quantifies the relationship.

Kᵢ: The constant (intercept) associated with demand group i.

C. The Sales Model is:

$$ln ( \frac{{\hat{S}}_{i , t}}{{S}_{Bi , t}} ) = {\hat{K}}_{i} + {\hat{γ}}_{i} \frac{{P}_{i , t}}{{\overline{P}}_{i , t}} + {\overline{v}}_{i} {M}_{i , t} + {\hat{ψ}}_{i} {X}_{i , t} + {\hat{κ}}_{i} {X}_{i , t} \frac{{P}_{i , t}}{{\overline{P}}_{i , t}} + {\sum }_{n = 1}^{τ} {\hat{δ}}_{i , n} \frac{{\sum }_{r = t - mn}^{t - m ( n - 1 ) - 1} {S}_{i , r}}{{\sum }_{r = t - mn}^{t - m ( n - 1 ) - 1} {\overline{S}}_{i , r}} + {\sum }_{j \neq i} {\hat{φ}}_{i , j} \frac{{\hat{S}}_{j , t}}{{\overline{S}}_{j , t}} + {\hat{η}}_{i , t} ( \frac{{\overline{P}}_{i , t} - {\overline{\overline{P}}}_{i , t}}{{\overline{\overline{P}}}_{i , t}} ) + {\hat{π}}_{i} \frac{{TS}_{t}}{T {\overline{S}}_{t}} + {\hat{θ}}_{i} \frac{{S}_{i , t - 7}}{{\overline{S}}_{i , t - 7}} \qquad Equation 1$$

In the above model (Equation 1), the dependent variable, demand group equivalent sales, is indexed (divided) by baseline demand group equivalent sales to provide a type of normalization. This normalizing allows easier comparison within a demand group and between demand groups. If a reasonable approximation of baseline demand group sales cannot be imputed, the dependent variable may alternatively be indexed by demand group equivalent sales averaged over a specified number of time periods prior to the current one ( S̅_{i,t}).

In the time lag term, τ represents the number of “time buckets” preceding a time period that will be included in the model, and m represents the size of the “time bucket,” in number of time periods.

Inclusion of several covariates (day-of-week, store traffic, within-market competitive pricing) is contingent upon the time dimension and scope of available client data. Therefore, if data is reported on a weekly basis, so that there is no data according to day of the week, the day of the week parameters will not be included.

D. Sales Model Unbiasing Factor

In regression calculations, returning to the original scale after a logarithmic transformation creates a bias. To correct for this bias, the Baskersville's method is used which consists of adding an unbiasing factor to the equation. This factor is the mean square error (\hat{σ}²) of the sales model divided by 2.

The equation for predicting demand group sales is thus:

$$( \frac{{\hat{S}}_{i , t}}{{S}_{Bi , t}} ) = exp ( \begin{matrix}{\hat{K}}_{i} + {\hat{γ}}_{i} \frac{{P}_{i , t}}{{\overline{P}}_{i , t}} + {\overline{v}}_{i} {M}_{i , t} + {\hat{ψ}}_{i} {X}_{i , t} + \\ {\hat{κ}}_{i} {X}_{i , t} \frac{{P}_{i , t}}{{\overline{P}}_{i , t}} + {\sum }_{n = 1}^{τ} {\hat{δ}}_{i , n} \frac{{\sum }_{r = t - mn}^{t - m ( n - 1 ) - 1} {S}_{i , r}}{{\sum }_{r = t - mn}^{t - m ( n - 1 ) - 1} {\overline{S}}_{i , r}} + \\ {\sum }_{j \neq i} {\hat{φ}}_{i , j} \frac{{\hat{S}}_{j , t}}{{\overline{S}}_{j , t}} + {\hat{η}}_{i , t} ( \frac{{\overline{P}}_{i , t} - {\overline{\overline{P}}}_{i , t}}{{\overline{\overline{P}}}_{i , t}} ) + \\ {\hat{π}}_{i} \frac{{TS}_{t}}{T {\overline{S}}_{t}} + {\hat{θ}}_{i} \frac{{S}_{i , t - 7}}{{\overline{S}}_{i , t - 7}} + \frac{{\hat{σ}}^{2}}{2}\end{matrix} ) \qquad Equation 2$$

4. Stage 2 (Share) Model

A. Share Model Multipliers (Data Values, or Covariates) and Dependent Variables

F_{i,k,t}: The fraction of demand group i equivalent sales comprised by product k in time period t (market share of product k).

F̅_{i,•,t}: The average fraction of demand group i equivalent sales with respect to time period t. To allow linear modeling of the regression equation, this data value is used to provide centering.

P_{Bi,k,t}: The equivalent base price of product k in demand group i in time period t.

P̅_{Bi,(k),t}: The average equivalent base price of all products other than product k in demand group i for time period t.

P_{R Bi,k,t}: The relative equivalent base price of product k in demand group i for time period t

$$( = \frac{{P}_{Bi , k , t}}{{\overline{P}}_{Bi , ( k ) , t}} ) .$$

P̅_{R Bi,•,t}: The average relative equivalent base price in demand group i for time period t.

M_{p,i,k,t}: The level of promotion type p (kind of promotion) for product k in demand group i in time period t. There can be up to nₚ promotion factors estimated in the model.

M̅_{p,i,•,t}: The average level of promotion type p in demand group i for time period t.

B. Share Model Factors (Parameters to be Estimated)

ρ_{i,k}: The relative base price elasticity factor for product k in demand group i.

σ_{p,i,k}: The promotion factor p for product k in demand group i. There can be up to nₚ promotion factors estimated in the model.

χ_{i,k,n}: The time lag factor for product k in demand group i and delay of n weeks.

Λ_{i,k}: The constant (intercept) associated with product k in demand group I.

The model for predicting product share (market share) is:

$${\hat{F}}_{i , k , t} = \frac{ exp \{ \begin{matrix}{\hat{Λ}}_{i , k} + {\hat{ρ}}_{i , k} ( {P}_{Ri , k , t} ) + \\ {\sum }_{p = 1}^{{n}_{p}} {\hat{σ}}_{p , i , k} ( {M}_{p , i , k , t} ) + \\ {\sum }_{n = 1}^{τ} {\hat{χ}}_{i , k , n} {\sum }_{r = t - mn}^{t - m ( n - 1 ) - 1} ( {F}_{i , k , r} )\end{matrix} \}}{{\sum }_{l ∈ {Dem}_{i}}^{ } exp \{ \begin{matrix}{\hat{Λ}}_{i , l} + {\hat{ρ}}_{i , l} ( {P}_{Ri , l , t} ) + \\ {\sum }_{p = 1}^{{n}_{p}} {\hat{σ}}_{p , i , l} ( {M}_{p , i , l , t} ) + \\ {\sum }_{n = 1}^{τ} {\hat{χ}}_{i , k , n} {\sum }_{r = t - mn}^{t - m ( n - 1 ) - 1} ( {F}_{i , l , r} )\end{matrix} \}} \qquad Equation 3$$

This model calculates demand for a product divided by demand for the demand group of the product.

The product intercept Λ_{i,k} is not individually estimated in the model. Instead, each product is characterized according to product attributes, such as brand, size group (small/medium/large), form, flavor, etc. . . . A store-specific estimate of the effect corresponding to each attribute level effects is obtained, and each product intercept is then constructed by summing over the applicable attribute level estimates.

Thus,

$${\hat{Λ}}_{i , k} = {\sum }_{a = 1}^{{n}_{a}} {\sum }_{b = 1}^{{n}_{b ( a )}} {\hat{ξ}}_{{a}_{b}} \cdot {I}_{k , {a}_{b}} ,$$

where ξₐ_{_{b}} is the effect of attribute a, level b, and

I_{k,a}_{_{b}} is an indicator variable for product

$$k , = \{ \begin{matrix}1 , if product has level b of a \\ 0 , else\end{matrix} \}$$

The attribute values may be used to predict sales of new products with various attribute combinations.

5. Linearization of Multinomial Logistic Equation

The multinomial logistic function that defines the market share equations for each product is nonlinear but there exist standard techniques to transform it to a linear function instead, which may make modeling easier. An example of a transformation to a linear function is as follows:

In this section the store index is ignored.

For a particular time period t:

$$Let {F}_{i , k} = \frac{exp ( {α}_{i , k} + {\sum }_{p = 1}^{P} {β}_{p} \cdot {X}_{pi , k} + {ɛ}_{i , k} )}{{\sum }_{j = 1}^{k} exp ( {α}_{i , j} + {\sum }_{p = 1}^{P} {β}_{p} \cdot {X}_{pi , j} + {ɛ}_{i , j} )} ,$$

where αᵢ is the intercept for demand group i, β are the covariates, and P is the number of covariates in the share model

$$log ( {F}_{i , k} ) = {α}_{i , k} + {\sum }_{p = 1}^{P} {β}_{p} \cdot {X}_{pi , k} + {ɛ}_{i , k} - log ( {\sum }_{j = 1}^{k} exp ( \begin{matrix}{α}_{i , j} + {\sum }_{p = 1}^{P} {β}_{p} \cdot \\ {X}_{pi , j} + {ɛ}_{i , j}\end{matrix} ) )$$

$$\begin{matrix}Let log ( {\tilde{F}}_{i} ) = \frac{1}{k} {\sum }_{j = 1}^{k} log ( {F}_{i , k} ) \\ = {\overline{α}}_{i} + {\sum }_{p = 1}^{P} {β}_{p} \cdot {\overline{X}}_{pi} + {\overline{ɛ}}_{i} - log ( {\sum }_{j = 1}^{k} exp ( \begin{matrix}{α}_{i , j} + {\sum }_{p = 1}^{P} {β}_{p} \cdot \\ {X}_{pi , j} + {ɛ}_{i , j}\end{matrix} ) )\end{matrix}$$

$$\begin{matrix} Thus , log ( \frac{{F}_{i , k}}{{\tilde{F}}_{i}} ) = {α}_{i , k} + {\sum }_{p = 1}^{P} {β}_{p} \cdot {X}_{pi , k} + \\ {ɛ}_{i} - log ( {\sum }_{j = 1}^{k} exp ( \begin{matrix}{α}_{i , j} + {\sum }_{p = 1}^{P} {β}_{p} \cdot \\ {X}_{pi , j} + {ɛ}_{i , j}\end{matrix} ) ) - \\ {\overline{α}}_{i} - {\sum }_{p = 1}^{P} {β}_{p} \cdot {\overline{X}}_{pi} - {\overline{ɛ}}_{i} + \\ log ( {\sum }_{j = 1}^{k} exp ( \begin{matrix}{α}_{i , j} + {\sum }_{p = 1}^{P} {β}_{p} \cdot \\ {X}_{pi , j} + {ɛ}_{i , j}\end{matrix} ) ) \\ = ( {α}_{i , k} - {\overline{α}}_{i} ) + {\sum }_{p = 1}^{P} {β}_{p} ( {X}_{pi , k} - {\overline{X}}_{pi} ) + ( {ɛ}_{i , j} - {\overline{ɛ}}_{i} )\end{matrix}$$

To model share in a linear framework, we simply center all covariates and model log(F_{i,k})−log(\tilde{F}ᵢ), where \tilde{F}ᵢ is geometric mean of F_{i,k}:

$$log ( {F}_{i , k , t} ) - log ( {\tilde{F}}_{i , \cdot , t} ) = {Λ}_{i , k , t} + {ρ}_{i , k} ( {P}_{Ri , k , t} - {\overline{P}}_{Ri , \cdot , t} ) + {\sum }_{p = 1}^{{n}_{p}} {σ}_{p , i , k} ( {M}_{p , i , k , t} - {\overline{M}}_{p , i , \cdot , t} ) + {\sum }_{n = 1}^{τ} {χ}_{i , k , n} {\sum }_{r = t - mn}^{t - m ( n - 1 ) - 1} ( {F}_{i , k , r} - {\overline{F}}_{i , \cdot , r} )$$

C. Combined (Product Sales) Model

The model for predicting sales for product k in demand group i in time period t is thus given by:

\hat{D}_{i,k,t}=\hat{F}_{i,k,t}Ŝ_{i,t}

### III. Financial Model Engine

The Financial Model Engine 108 receives data 132 from the Stores 124 and may receive imputed variables (such as baseline sales and baseline prices) and data from the Econometric Engine 104 to calculate fixed and variable costs for the sale of each item.

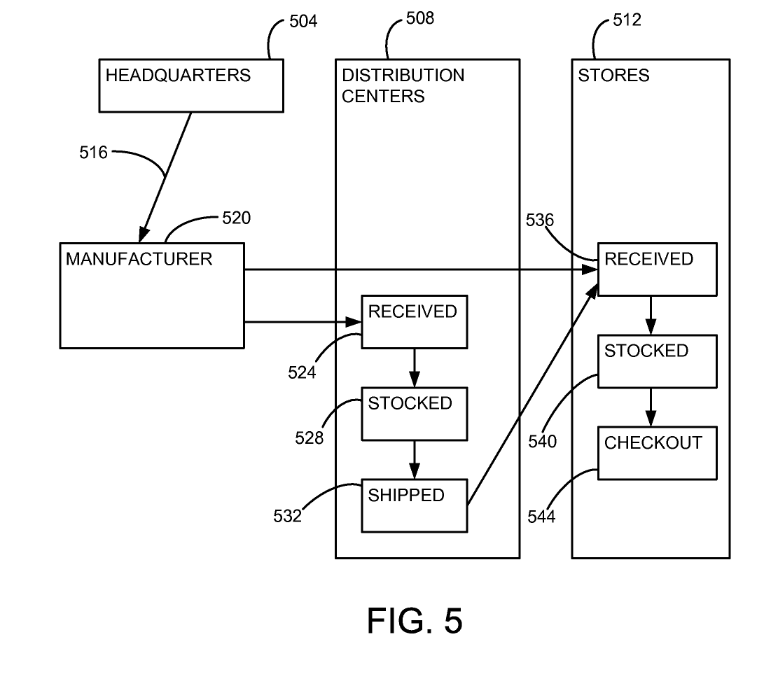

To facilitate understanding, FIG. 5 is an exemplary block diagram to illustrate some of the transaction costs that occur in retail businesses of a chain of stores. The chain of stores may have a headquarters 504, distribution centers 508, and stores 512. The headquarters 504 may place an order 516 to a manufacturer 520 for goods supplied by the manufacturer 520, which generates an order placement cost. The manufacturer 520 may ship the goods to one of the distribution centers 508. The receiving of the goods by the distribution center 508 generates a receiving cost 524, a cost for stocking the goods 528, and a cost for shipping the goods 532 to one of the stores 512. The store 512 receives the goods from one of the distribution centers 508 or from the manufacturer 520, which generates a receiving cost 536 and a cost for stocking the goods 540. When a customer purchases the item, the stores 512 incur a check-out cost 544.

The Financial Model Engine 108 should be flexible enough to provide a cost model for these different procedures. These different costs may have variable cost components where the cost of an item is a function of the amount of sales of the item and fixed cost components where the cost of an item is not a function of the amount of sales of the item. Financial Model Engine 108, thus, may generate a model that accounts for procurement costs in addition to the various costs associated with conducting business.

### IV. Optimization Engine and Support Tool

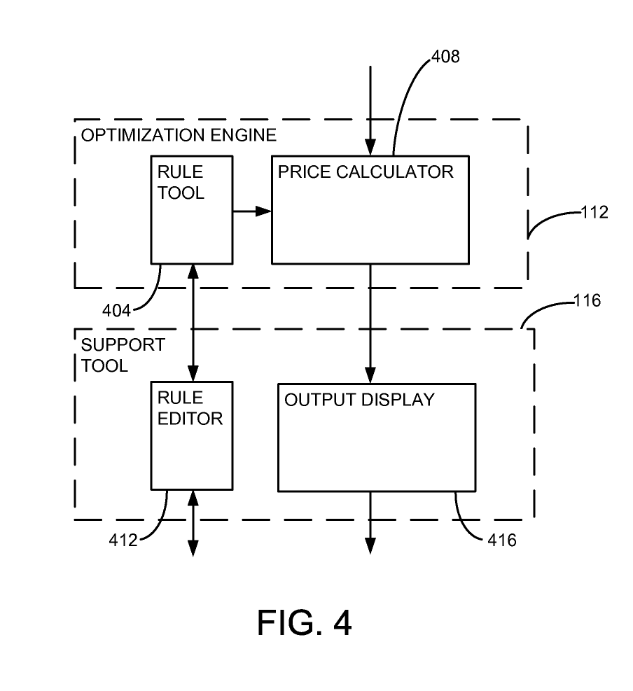

FIG. 4 is a more detailed schematic view of the Optimization Engine 112 and the Support Tool 116. The Optimization Engine 112 comprises a rule tool 404 and a price calculator 408. The Support Tool 116 comprises a rule editor 412 and an output display 416.

In operation, the client (stores 124) may access the rule editor 412 of the Support Tool 116 and provides client defined rule parameters (step 228). If a client does not set a parameter for a particular rule, a default value is used. Some of the rule parameters set by the client may be constraints to the overall weighted price advance or decline, branding price rules, size pricing rules, unit pricing rules, line pricing rules, and cluster pricing rules. The client defined parameters for these rules are provided to the rule tool 404 of the Optimization Engine 112 from the rule editor 412 of the Support Tool 116. Within the rule tool 404, there may be other rules, which are not client defined, such as a group sales equation rule. The rule parameters are outputted from the rule tool 404 to the price calculator 408. The demand coefficients 128 and cost data 136 are also inputted into the price calculator 408. The client may also provide to the price calculator 408 through the Support Tool 116 a desired optimization scenario rules. Some examples of scenarios may be to optimize prices to provide the optimum profit, set one promotional price and the optimization of all remaining prices to optimize profit, or optimized prices to provide a specified volume of sales for a designated product and to optimize price. The price calculator 408 then calculates optimized prices. The price calculator 408 outputs the optimized prices to the output display 416 of the Support Tool 116, which allows the Stores 124 to receive the optimized pricing (step 232).

### V. Coefficient Tuning Engine

A. System Overview

FIG. 21 is a more detailed schematic view of the Coefficient Tuning Engine 150. The Coefficient Tuning Engine 150 may include at least one of a Deficient Category Identifier 2102, a Data Seeder 2104, a Tuning Parameter Value Estimator 2106 and a Coefficient Generator 2108. Each subunit of the Coefficient Tuning Engine 150 may be coupled to one another. Each component of the Coefficient Tuning Engine 150 may include dedicated hardware components, software processes or software modules.

As previously mentioned, the Coefficient Tuning Engine 150 may be a stand alone system or may be associated with a pricing optimization system, as is illustrated in FIG. 1. Additionally, the Coefficient Tuning Engine 150 may be a module within the Pricing Optimization System 100, or may be a subcomponent of the Econometric Engine 104.

Data 152 may be received by the Coefficient Tuning Engine 150. This Data 152 may include raw Point of Sales (POS) data generated by the Stores 124. Additionally, the Data 152 may include historic sales data. In some embodiments, Data may include cleansed data from the Econometric Engine 104. In some alternate embodiments, the raw data received may undergo a data cleansing process similar to the one described above. In addition, other known data cleansing processes may be performed on the incoming Data 152.

The Deficient Category Identifier 2102 may parse the historic pricing data as well as the recent pricing and sales data to determine which products, or categories of products, are in need of coefficient tuning. Again, these products, or categories of products, tend to include products with a sparse pricing history. Such poor pricing histories may result from a new product or product category, new stores, or long-term stability of the product's price.

The Data Seeder 2104 may seed the Data 152 with highly generic values for price elasticity (γ) and for uncertainty (s). Incorporation of these artificial values may be necessary because at first run there may be insufficient data available to generate values for these coefficients.

The Tuning Parameter Value Estimator 2106 may generate estimates for tuning parameters. Tuning parameters include the weighted mean (μ) of the price elasticity as well as the standard deviation (σ) of the price elasticity. Estimating the tuning parameters begins by selecting the price elasticity (γ) and uncertainty (s) by obtaining listings of these coefficients from prior run categories. Thus, coefficients generated for other products, or product categories, may be borrowed to supplant the coefficients of products that have less rich pricing histories. Selection of categories which coefficients are used may rely upon a default selection or may rely upon user input for selecting the categories. In some embodiments, the default may include all previous categories. In some alternate embodiments, the default may compare product categories descriptions and select other comparable categories. For example, if the deficient category is “Italian foods”, the category used for estimating the coefficients may include “Mexican foods” by looking at product category descriptions.

Thus, given N categories that provide the price elasticity (γ) and uncertainty (s), a generic weighted mean may be calculated, as shown below:

$$μ = \frac{{\sum }_{i = 1}^{N} \frac{{γ}_{i}}{{s}_{i}^{2}}}{( {\sum }_{i = 1}^{N} \frac{1}{{s}_{i}^{2}} )}$$

Likewise, the standard deviation (σ) may be calculated given the N categories that provide the price elasticity (γ) and uncertainty (s), as shown below:

$${σ}^{2} = \frac{1}{{\sum }_{i = 1}^{N} \frac{1}{{s}_{i}^{2}}} ( {\sum }_{i = 1}^{N} \frac{{( γ - μ )}^{2}}{{s}_{i}^{2}} + N )$$

Thus, in this fashion, the tuning parameters weighted mean (μ) of the price elasticity as well as the standard deviation (σ) of the price elasticity may be estimated using the prior category price elasticity and certainty.

The Coefficient Generator 2108 may then generate the tuned Demand Coefficients 128. The demand coefficients may be generated by inputting the estimated tuning parameters into a modified posterior likelihood function.

From the Equation 1 above, a likelihood function is implied having the form:

$$ln ( l \{ \hat{{S}_{i , t}} \} \vert \hat{{K}_{i}} , \hat{{γ}_{i}} , \hat{{v}_{i}} , \hat{{ψ}_{i}} , \hat{{κ}_{i}} , \hat{{δ}_{i}} , \hat{{φ}_{i}} , \hat{{n}_{i}} , \hat{{π}_{i}} , \hat{{θ}_{i}} , ) = - ln ( ζ ) - {\sum }_{t}^{ } \frac{( \begin{matrix}{\hat{K}}_{i} + {\hat{γ}}_{i} \frac{{P}_{i , t}}{{\overline{P}}_{i , t}} + {\hat{v}}_{i} {M}_{i , t} + {\hat{ψ}}_{i} {X}_{i , t} + {\hat{κ}}_{i} {X}_{i , t} \frac{{P}_{i , t}}{{\overline{P}}_{i , t}} + \\ {\sum }_{n = 1}^{τ} {\hat{δ}}_{i , n} {{-}^{…}}_{…} + TODO - ln ( \frac{{\hat{S}}_{i , t}}{{S}_{Bi , t}} )\end{matrix} )}{2 {ζ}^{2}}$$

In this case, the set of observed sales volumes {Ŝ_{i,t}} takes the role of the data, and it may be assumed that one or more of the coefficients \hat{K}ᵢ, \hat{γ}ᵢ, \hat{ν}ᵢ, \hat{ψ}ᵢ, \hat{κ}ᵢ, \hat{δ}ᵢ, \hat{φ}ᵢ, \hat{n}ᵢ, \hat{π}ᵢ, \hat{θ}ᵢ may be used in the role of the parameter β. For convenience the entire coefficient set may be denoted as Ω.

The posterior likelihood function may then be calculated as:

l′(Ω|{Ŝ_{i,t}})=l({Ŝ_{i,t}}|Ω)p(γ)

The optimal values for the set of coefficients Ω may be found by maximizing the posterior likelihood function l′(Ω|{Ŝ_{i,t}}) with respect to Ω.

Further, the price elasticity term (γ) may be equated to a normally distributed prior. Thus,

$$γ \text{\textasciitilde} N ( μ , {σ}^{2} )$$

$$p ( γ ) \text{\textasciitilde} exp ( - \frac{{( γ - μ )}^{2}}{2 {σ}^{2}} )$$

Thus, a modified likelihood function may be generated as:

$${l}^{′} ( Ω \vert \{ {\hat{S}}_{i , t} \} ) = l ( \{ {\hat{S}}_{i , t} \} \vert Ω ) exp ( - \frac{{( γ - μ )}^{2}}{2 {σ}^{2}} )$$

The estimated parameters from the Tuning Parameter Value Estimator 2106 may be input into the modified posterior likelihood function. The modified function may then be maximized via function analysis or by passing the logarithm through a multivariate numerical optimization routine. The results of the maximization will provide the Demand Coefficients 128 denoted as Ω.

Additionally, the value of the category's uncertainty (s) may be estimated from the equation:

$${s}^{- 2} = - \frac{{d}^{2} }{d {γ}^{2}} log ( {l}^{′} ( Ω \vert \{ {\hat{S}}_{i , t} \} ) )$$

The resulting values of γ and s may then be stored for later use when modeling later categories.

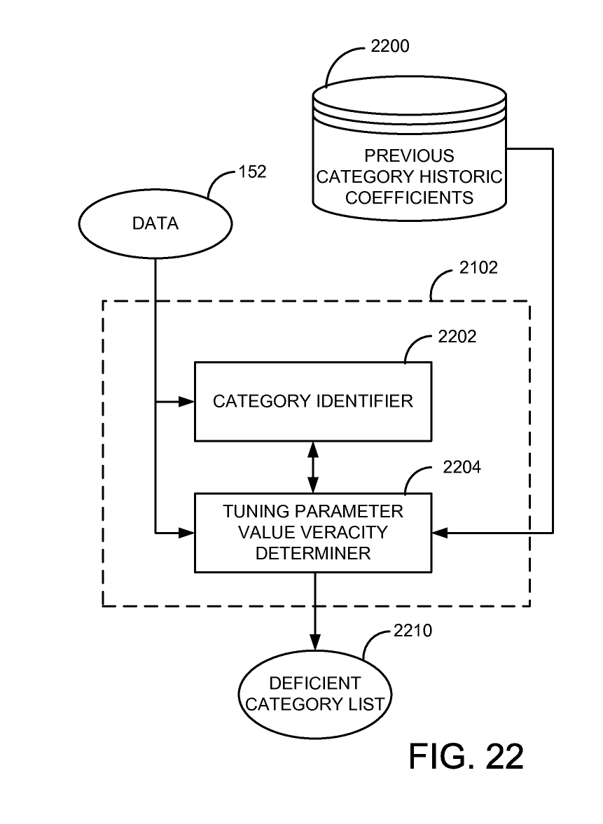

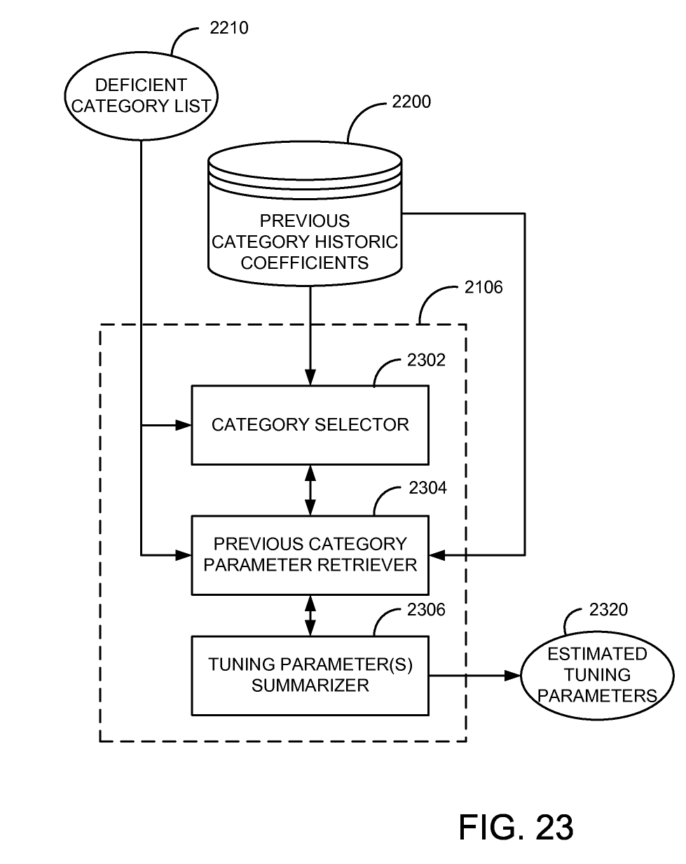

FIG. 22 is a more detailed schematic view of the Deficient Category Identifier 2102 of the Coefficient Tuning Engine 150. The Deficient Category Identifier 2102 receives the Data 152 from the stores. Additionally, data from a Previous Category Historic Coefficients Database 2200 may be received by the Deficient Category Identifier 2102. The Deficient Category Identifier 2102 may include a Category Identifier 2202 and a Tuning Parameter Value Veracity Determiner 2204. The Category Identifier 2202 may determine the category the Data 152 belongs to, and may determine which categories the coefficients are being generated for.

The Tuning Parameter Value Veracity Determiner 2204 may generate a relative value for how “rich” the pricing history of the category is. This richness value may be compared to a threshold to determine if there is enough pricing history to generate accurate demand coefficients, of if generation of tuned demand coefficients would be more prudent. Categories which have deficient pricing data may then be added to a List 2210 of candidate categories for generation of tuned coefficients.

FIG. 23 is a more detailed schematic view of the Tuning Parameter Value Estimator 2106 of the Coefficient Tuning Engine 150. The Tuning Parameter Value Estimator 2106 receives historic pricing and coefficient data from the Database 2200. Likewise, those categories requiring tuned coefficients may be received from the Deficient Category Identifier 2102 via the Deficient Category List 2210.

The Tuning Parameter Value Estimator 2106 may include a Category Selector 2302 a Previous Category Parameter Retriever 2304 and a Tuning Parameter Summarizer 2306. The Category Selector 2302 may select which historic prior categories to use for the parameter estimation. As previously mentioned, this selection may include a default of all prior categories, or may include an interface for user configuration of which categories to use. Additionally, categories may be selected dependent upon category descriptions in order to match categories to similar performance categories. Selection of the categories includes providing the price elasticity (γ) and uncertainty (s) to the Previous Category Parameter Retriever 2304.

The Previous Category Parameter Retriever 2304 may generate tuning parameters (μ,σ) from the price elasticity (γ) and uncertainty (s) as detailed above. These Tuning Parameters 2320 may be summarized and output by the Tuning Parameter Summarizer 2306.

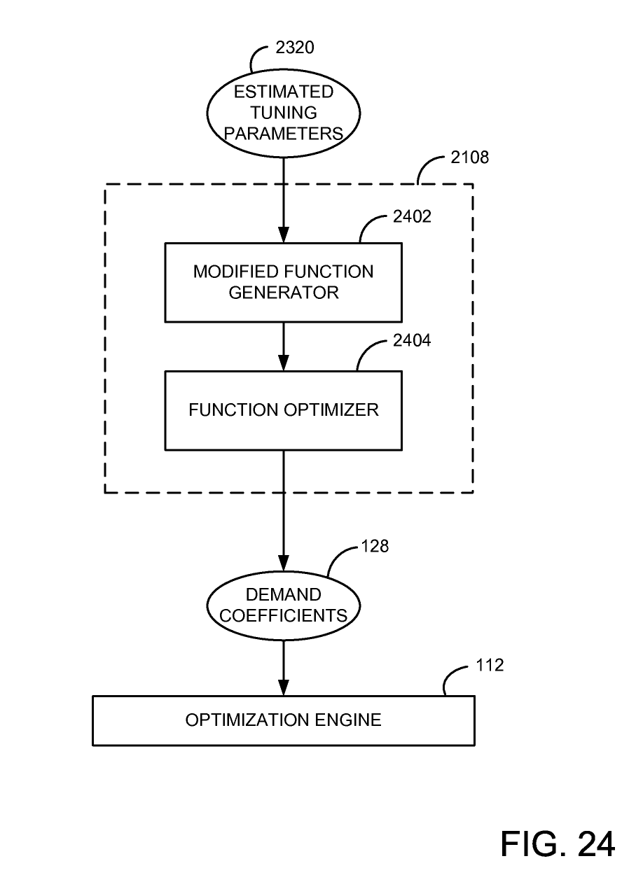

FIG. 24 is a more detailed schematic view of the Tuning Parameter Value Estimator 2106 of the Coefficient Tuning Engine 150. Here can be seen the Estimated Tuning Parameters 2320 being received by the Tuning Parameter Value Estimator 2106. The Tuning Parameter Value Estimator 2106 may include a Modified Function Generator 2402 and a Function Optimizer 2404. The Modified Function Generator 2402 may generate the modified posterior function, as detailed above, including the received Tuning Parameters 2320. Then the modified function may be maximized using function analysis or via running the logarithm through a multivariate numerical optimization routine. The results of the maximization will provide the Demand Coefficients 128. The demand coefficients may then be output to the Optimization Engine 112, or output for other downstream application(s).

B. Coefficient Tuning

FIG. 25 is a flowchart depicting a process flow by which coefficient tuning may be performed in accordance with some embodiment of the present invention, shown generally at 210. The process begins from step 208 of FIG. 2. The process then progresses to step 2502 where store data is received. This data may include raw point of sales data as well as cleansed data. Additionally, historic pricing and sales data may be received as well.

The process then progresses to step 2504 where categories with poor pricing histories are identified since these categories of products may result in inaccurate demand coefficients. These identified categories are then selected for generation of tuned demand coefficients. Pricing history rich categories may have their demand coefficients generated directly from the pricing history.

The process then progresses to step 2506 where generic coefficients values are generated. These generic values may be used to seed the dataset, at step 2508. Next, at step 2510 the tuning parameters may be estimated by selecting prior categories and using the price elasticity and uncertainty values to generate the mean and standard deviation tuning parameters.

The process then progresses to step 2512 where the tuned coefficients are generated by inputting the estimated tuning parameters into a modified likelihood function and solving for the maximum of said function. The process then concludes by progressing to step 212 of FIG. 2.

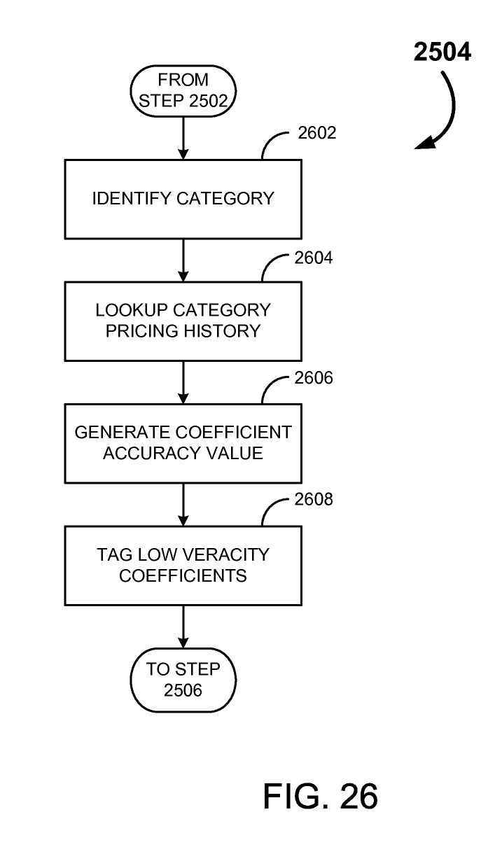

FIG. 26 is a flowchart depicting a process flow by which deficient coefficients are identified in accordance with some embodiment of the present invention, shown generally at 2504. The process begins from step 2502 of FIG. 25. The process then progresses to step 2602 where the category being analyzed is identified. A lookup of the pricing history for that category may be performed at step 2604. At step 2606, a coefficient accuracy value may be generated by comparing the relative richness of pricing history of the product category. The richer the pricing history for a given product category, the higher the accuracy of the generated coefficients. The coefficient accuracy value may be compared to a threshold, and categories with low, or deficient, pricing history may be tagged, at step 2608, for the generation of tuned coefficients. The process then concludes by progressing to step 2506 of FIG. 25.

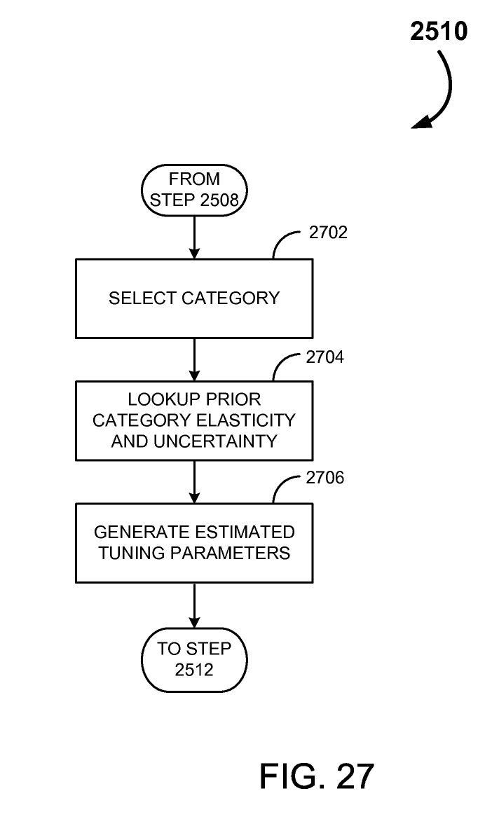

FIG. 27 is a flowchart depicting a process flow by which tuning parameters are estimated in accordance with some embodiment of the present invention, shown generally at 2510. The process begins from step 2508 of FIG. 25. The process then progresses to step 2702 where the category for estimating tuning parameters are selected. One or more prior categories may be selected for estimating tuning parameters. Category selection may include all priors, user selection, similar categories based upon category description, or any other reasonable selection method. For example, it is possible that only categories with a sufficiently rich pricing history be used for tuning parameter estimation.

The process then progresses to step 2704 where prior tuning price elasticity (γ) and uncertainty (s) are retrieved. Using these prior coefficients, the tuning parameters (μ,σ) may be generated, at step 2706, using the calculations and in the manner detailed above. The process then concludes by progressing to step 2512 of FIG. 25.

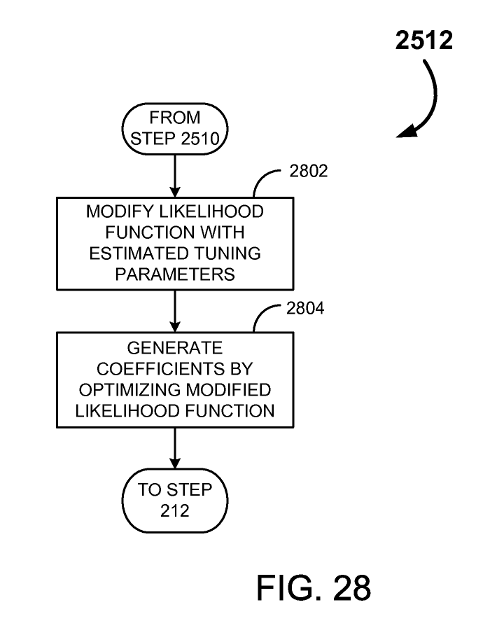

FIG. 28 is a flowchart depicting a process flow by which tuned coefficients are generated in accordance with some embodiment of the present invention, shown generally at 2512. The process begins from step 2510 of FIG. 25. The process then progresses to step 2802 where the modified posterior likelihood function is generated utilizing the tuning parameters estimated at step 2510 of FIG. 25. The demand coefficients may then be generated, at step 2804, by maximizing the generated likelihood function. The maximization may be performed via function analysis of by passing the logarithm of the equation to a multivariate numerical optimization routine. The generated coefficients may be used for modeling demand and generating optimized prices. Additionally, the coefficients may be stored for further tuning of later product categories. The process then concludes by progressing to step 212 of FIG. 2.

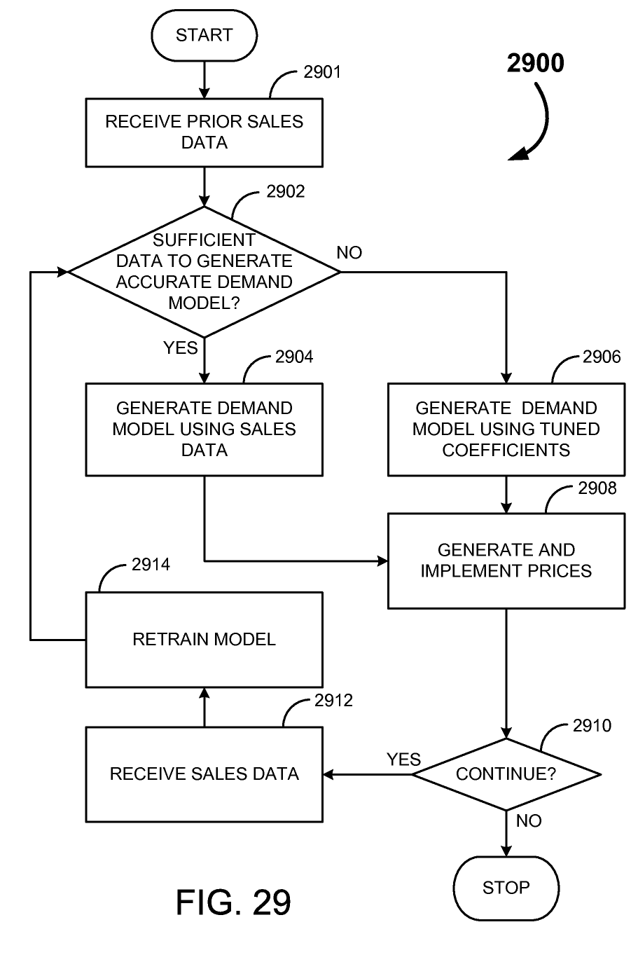

FIG. 29 is a flowchart depicting an alternate process flow by which optimized prices may be generated using a coefficient tuning stratagem in accordance with some embodiment of the present invention, shown generally at 2900. The process begins and progresses to step 2901 where prior sales data is received.

The process then progresses to step 2902 where an inquiry is made as to whether there is sufficient data to generate an accurate demand model. This inquiry may rely upon the above method of generating an accuracy value for the coefficients dependent upon relative richness of the pricing history. If the pricing history is rich enough to support an accurate demand model, the process then progresses to step 2904 where the demand model may be modeled using coefficients generated from the past and current sales and pricing history. The process then progresses to step 2908 where optimized prices are generated and implemented. Price generation may use the developed demand models to optimize for a given business goal, including, but not limited to, profit maximization, volume goals and margin goals.

Else, if the pricing data is insufficient to generate accurate demand models at step 2902, the process then progresses to step 2906 where the demand model is generated using tuned coefficients. The method of generating the tuned coefficients may mirror the method detailed above in conjunction with FIG. 25. The process then progresses to step 2908 where optimized prices are generated and implemented.

The process then progresses to step 2910 where an inquiry is made as to whether to continue. If continuation is not desired, the process may end. Otherwise, new sales data from the implemented prices may be received at step 2912. The models may be retrained to reflect the new sales data at step 2914. The process then progresses to step 2902 where an inquiry is made as to whether there is sufficient data to generate an accurate demand model. In this way, the process is able to improve models iteratively.

### VI. System Platform

FIGS. 7A and 7B illustrate a computer system 900, which forms part of the network 10 and is suitable for implementing embodiments of the present invention. FIG. 7A shows one possible physical form of the computer system. Of course, the computer system may have many physical forms ranging from an integrated circuit, a printed circuit board, and a small handheld device up to a huge super computer. Computer system 900 includes a monitor 902, a display 904, a housing 906, a disk drive 908, a keyboard 910, and a mouse 912. Disk 914 is a computer-readable medium used to transfer data to and from computer system 900.

FIG. 7B is an example of a block diagram for computer system 900. Attached to system bus 920 are a wide variety of subsystems. Processor(s) 922 (also referred to as central processing units, or CPUs) are coupled to storage devices, including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data, and the like and is typically a secondary storage medium (such as a hard disk) that is slower than primary storage. It will be appreciated that the information retained within fixed disk 926 may, in appropriate cases, be incorporated in standard fashion as virtual memory in memory 924. Removable disk 914 may take the form of any of the computer-readable media described below.

CPU 922 is also coupled to a variety of input/output devices, such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

FIG. 8 is a schematic illustration of an embodiment of the invention that functions over a computer network 800. The network 800 may be a local area network (LAN) or a wide area network (WAN). An example of a LAN is a private network used by a mid-sized company with a building complex. Publicly accessible WANs include the Internet, cellular telephone network, satellite systems and plain-old-telephone systems (POTS). Examples of private WANs include those used by multi-national corporations for their internal information system needs. The network 800 may also be a combination of private and/or public LANs and/or WANs. In such an embodiment, the Price Optimizing System 100 is connected to the network 800. The Stores 124 are also connected to the network 800. The Stores 124 are able to bi-directionally communicate with the Price Optimizing System 100 over the network 800. Additionally, in embodiments where the Coefficient Tuning Engine 150 is not integrated within the pricing optimization system, the Stores 124 are likewise able to bi-directionally communicate with the Coefficient Tuning Engine 150 over the network 800.

Additionally, in some embodiments, the system may be hosted on a web platform. A browser or similar web component may be used to access the Likelihood of loss engine. By utilizing internet based services, retailers may be able to access the system from any location.

In the specification, examples of product are not intended to limit products covered by the claims. Products may for example include food, hardware, software, real estate, financial devices, intellectual property, raw material, and services. The products may be sold wholesale or retail, in a brick and mortar store or over the Internet, or through other sales methods.

In sum, the present invention provides a system and methods for the tuning of demand coefficients. The advantages of such a system include the ability to generate faithful demand coefficients in scenarios where less than optimal historic data is available. Such tuning ensures that the demand models generated are accurate, and alleviates sporadic and inaccurate swings in generated product prices.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for tuning demand coefficients for a first product category, useful in association with a pricing optimization system, the method comprising:
receiving data from at least one store, wherein the data includes transactions associated with at least one product category;
selecting price elasticity and uncertainty values from at least one of the at least one product category;
estimating tuning parameters for the first product category, wherein the tuning parameters include price elasticity mean and price elasticity standard deviation, and wherein estimating the tuning parameters uses the selected price elasticity and uncertainty values;
generating a modified likelihood function by applying a normally distributed price elasticity term; and
generating tuned demand coefficients by maximizing the modified likelihood function.

2. The method recited by claim 1, further comprising seeding the data with generic price elasticity and uncertainty values.

3. The method recited by claim 1, further comprising identifying the first product category as a product category having deficient pricing history.

4. The method recited by claim 1, wherein the price elasticity mean is defined by the equation:
$$μ = \frac{{\sum }_{i = 1}^{N} \frac{{γ}_{i}}{{s}_{i}^{2}}}{( {\sum }_{i = 1}^{N} \frac{1}{{s}_{i}^{2}} )}$$
wherein,
N=the number of the product category;
μ=the price elasticity mean;
γ=the price elasticity; and
s=the uncertainty.

5. The method recited by claim 1, wherein the price elasticity standard deviation is defined by the equation:
$${σ}^{2} = \frac{1}{{\sum }_{i = 1}^{N} \frac{1}{{s}_{i}^{2}}} ( {\sum }_{i = 1}^{N} \frac{{( γ - μ )}^{2}}{{s}_{i}^{2}} + N )$$
wherein,
N=the number of the product category;
μ=the price elasticity mean;
σ=the standard deviation;
γ=the price elasticity; and
s=the uncertainty.

6. The method recited by claim 1, wherein maximizing the modified likelihood function includes at least one of maximizing the function analytically, and passing a logarithm of the likelihood function to a multivariate numerical optimization routine.

7. The method recited by claim 1, further comprising outputting the generated tuned demand coefficients to the pricing optimization system for product price setting.

8. The method recited by claim 1, further comprising receiving new sales data from the at least one store.

9. The method recited by claim 8, further comprising retraining the tuned demand coefficients in response to the newly received sales data.

10. The method recited by claim 1, further comprising storing the tuned demand coefficients for later product categories.

11. A demand coefficient tuner for a first product category, useful in association with a pricing optimization system, the demand coefficient tuner comprising:
an input configured to receive data from at least one store, wherein the data includes transactions associated with at least one product category;
a category selector configured to select price elasticity and uncertainty values from at least one of the at least one product category;
a tuning parameter estimator configured to estimate tuning parameters for the first product category, wherein the tuning parameters include price elasticity mean and price elasticity standard deviation, and wherein estimating the tuning parameters uses the selected price elasticity and uncertainty values;
a function modifier configured to generate a modified likelihood function by applying a normally distributed price elasticity term; and
a coefficient generator configured to generate tuned demand coefficients by maximizing the modified likelihood function.

12. The demand coefficient tuner of claim 11, further comprising a data seeder configured to seed the data with generic price elasticity and uncertainty values.

13. The demand coefficient tuner of claim 11, further comprising a deficient category identifier configured to identify the first product category as a product category having deficient pricing history.

14. The demand coefficient tuner of claim 11, wherein the price elasticity mean is defined by the equation:
$$μ = \frac{{\sum }_{i = 1}^{N} \frac{{γ}_{i}}{{s}_{i}^{2}}}{( {\sum }_{i = 1}^{N} \frac{1}{{s}_{i}^{2}} )}$$
wherein,
N=the number of the product category;
μ=the price elasticity mean;
γ=the price elasticity; and
s=the uncertainty.

15. The demand coefficient tuner of claim 11, wherein the price elasticity standard deviation is defined by the equation:
$${σ}^{2} = \frac{1}{{\sum }_{i = 1}^{N} \frac{1}{{s}_{i}^{2}}} ( {\sum }_{i = 1}^{N} \frac{{( γ - μ )}^{2}}{{s}_{i}^{2}} + N )$$
wherein,
N=the number of the product category;
μ=the price elasticity mean;
σ=the standard deviation;
γ=the price elasticity; and
s=the uncertainty.

16. The demand coefficient tuner of claim 11, wherein maximizing the modified likelihood function includes at least one of maximizing the function analytically, and passing a logarithm of the likelihood function to a multivariate numerical optimization routine.

17. The demand coefficient tuner of claim 11, further comprising an outputter configured to output the generated tuned demand coefficients to the pricing optimization system for product price setting.

18. The demand coefficient tuner of claim 11, wherein the input is further configured to receive new sales data from the at least one store.

19. The demand coefficient tuner of claim 18, further comprising a coefficient trainer configured to retrain the tuned demand coefficients in response to the newly received sales data.

20. The demand coefficient tuner of claim 11, further comprising a database configured to store the tuned demand coefficients for later product categories.
